(19) United States
(12) Patent Application Publication
(10) Pub. No.: US 2013/0299517 A1
(43) Pub. Date: Nov. 14, 2013

(54) PULL-ACTIVATED FOAM PUMPS, DISPENSERS AND REFILL UNITS

(71) Applicants: Nick E. Ciavarella, Seven Hills, OH (US); Robert L. Quinlan, Stow, OH (US); John J. McNulty, Broadview Heights, OH (US); James M. Yates, Akron, OH (US)

(72) Inventors: Nick E. Ciavarella, Seven Hills, OH (US); Robert L. Quinlan, Stow, OH (US); John J. McNulty, Broadview Heights, OH (US); James M. Yates, Akron, OH (US)

(73) Assignee: GOJO Industries, Inc., Akron, OH (US)

(21) Appl. No.: 13/791,225

(22) Filed: Mar. 8, 2013

Related U.S. Application Data
(60) Provisional application No. 61/644,699, filed on May 9, 2012.

(51) Int. Cl. B67D 7/76

(52) U.S. Cl. CPC B05B 7/0037; B67D 7/62; B67D 7/84
USPC 222/190

(57) ABSTRACT

Foam dispenser systems, pumps and refill units are disclosed herein. A refill unit for refilling a foam dispenser system comprises a container for holding a supply of foamable liquid and a foam pump connected to the container. The pump incorporates a simple and inexpensive valve arrangement to move liquid through the pump and to create the foam. For example, a liquid foam pump may include a housing and a valve stem that moves in two directions. The valve stem has an inlet liquid pathway and an outlet liquid pathway to convey liquid to a mixing. In addition, a moveable valve body is movable by the valve stem in a first direction to move the valve body to the first position to open a liquid inlet pathway, and moveable in a second direction to move the valve body to the second position to open the outlet liquid pathway.

### RELATED APPLICATIONS

This non-provisional utility patent application claims priority to and the benefits of U.S. Provisional Patent Application Ser. No. 61/644,699 filed on May 9, 2012 and entitled PULL-ACTIVATED FOAM PUMP. This application is incorporated herein by reference in its entirety.

### TECHNICAL FIELD

The present invention relates generally to foam dispenser systems and more particularly to pull-activated foam pumps, as well as disposable refill/replacement units for use in such foam pumps.

### BACKGROUND OF THE INVENTION

Liquid dispenser systems, such as liquid soap and sanitizer dispensers, provide a user with a predetermined amount of liquid upon actuation of the dispenser. In addition, it is sometimes desirable to dispense the liquid in the form of foam by, for example, injecting air into the liquid to create a foamy mixture of liquid and air bubbles. As a general matter, it is usually preferable to reduce the space taken up by the pumping and foaming apparatus within the overall dispenser system. This maximizes the available space for storing the liquid, and has other benefits.

### SUMMARY

Foam dispenser systems and pumps for use in foam dispenser systems are disclosed herein. In one embodiment, a refill unit for refilling a foam dispenser system comprises a container for holding a supply of foamable liquid and a foam pump connected to the container. Corresponding methods of manufacture are provided as well.

A liquid foam pump may include a housing and a valve stem that moves in two directions. The valve stem has an inlet liquid pathway and an outlet liquid pathway to convey liquid to a mixing. In addition, a moveable valve body is movable by the valve stem in a first direction to move the valve body to the first position to open a liquid inlet pathway, and moveable in a second direction to move the valve body to the second position to open the outlet liquid pathway.

A liquid foam pump including a pump body and a valve stem portion located at least partly within the pump body is provided herein. The valve stem portion moves in opposite first and second directions within the pump body along a longitudinal axis. The valve stem portion has a liquid pathway therein which extends from an inlet at a liquid charge chamber defined at least in part by the pump body to a mixing chamber defined within the valve stem portion. A first disk connected to the valve stem portion and comprising at least one liquid pathway within the pump body through or past the first disk is provided. In addition, the pump includes a flexible member connected to the valve stem portion and located between the first disk and the valve stem liquid pathway inlet. The flexible member flexes between a first position and a second position with respect to the valve stem portion, such that in the first position the flexible member opens the first disk liquid pathway and closes the valve stem liquid pathway, and in the second position the flexible member closes the first disk liquid pathway and opens the valve stem liquid pathway. Movement of the valve stem portion in the first direction moves the flexible member to the first position, and movement of the valve stem in the second direction moves the flexible member to the second position.

A liquid foam pump including a liquid charge chamber with a liquid inlet and a first valve through which liquid may enter the liquid charge chamber is disclosed herein. The liquid pump includes a liquid outlet and a second valve through which liquid may pass from the liquid charge chamber. A mixing chamber with a liquid inlet to receive liquid from the liquid outlet of the liquid charge chamber, and an air inlet to receive pressurized air from a pressurized air source, such that the liquid and the pressurized air are mixed within the mixing chamber to form a foamable mixture is also provided. The foam pump further includes a foam enhancing media which receives the foamable mixture, wherein a foaminess of the foamable mixture is enhanced as it passes through the foam enhancing media. Also included is an outlet nozzle for dispensing the enhanced foamable mixture and a suck-back mechanism to prevent foam that is not dispensed during a pumping action from dripping out of the outlet nozzle after the pumping action is completed. When the refill unit is installed in a dispenser, a portion of the suck-back mechanism forms a portion of an air pump that is disposed within the foamable liquid dispenser. The refill unit is disposable without disposing of the entire air pump.

In this way simple and economical foam dispenser systems, as well as refill units for use in such systems, are provided.

### BRIEF DESCRIPTION OF THE DRAWINGS

These and other features and advantages of the present invention will become better understood with regard to the following description and accompanying drawings in which:

FIG. 1A is a cross-sectional illustration of a first exemplary embodiment of a foam pump 100, in a priming or primed state;

FIG. 1B is a cross-sectional illustration of the foam pump 100, oriented perpendicularly to the view of FIG. 1A;

FIG. 2A is a cross-sectional illustration of the foam pump 100, in an intermediate pumping state;

FIG. 2B is a cross-sectional illustration of the foam pump 100, oriented perpendicularly to the view of FIG. 2A;

FIG. 3A is a cross-sectional illustration of the foam pump 100, in a final pumping state;

FIG. 3B is a cross-sectional illustration of the foam pump 100, oriented perpendicularly to the view of FIG. 3A;

FIG. 4A is a cross-sectional illustration of the foam pump 100, in an intermediate pumping state;

FIG. 4B is a cross-sectional illustration of the foam pump 100, oriented perpendicularly to the view of FIG. 4A;

FIG. 5A is a cross-sectional illustration of a second exemplary embodiment of a foam pump 200, in a priming or primed state;

FIG. 5B is a cross-sectional illustration of the foam pump 200, oriented perpendicularly to the view of FIG. 5A;

FIG. 6A is a cross-sectional illustration of the foam pump 200, in an intermediate pumping state;

FIG. 6B is a cross-sectional illustration of the foam pump 200, oriented perpendicularly to the view of FIG. 6A;

FIG. 7A is a cross-sectional illustration of the foam pump 200, in a final pumping state;

FIG. 7B is a cross-sectional illustration of the foam pump 200, oriented perpendicularly to the view of FIG. 7A;

FIG. 8A is a cross-sectional illustration of the foam pump 200, in an intermediate pumping state;

FIG. 8B is a cross-sectional illustration of the foam pump 200, oriented perpendicularly to the view of FIG. 8;

FIG. 9 is a side perspective view of a foam dispenser system 50 with a third exemplary embodiment of a foam pump 300, in a priming or primed state;

FIG. 10 is a side perspective view of the foam dispenser system 50 and foam pump 300, in a final pumping state;

FIG. 11 is a cross-sectional illustration of the foam pump 300, in a priming or primed state;

FIG. 12 is a cross-sectional illustration of the foam pump 300, in a final pumping state;

FIG. 13 is a cross-sectional illustration of the foam pump 300, in an intermediate pumping state;

FIG. 14 is a cross-sectional illustration of the foam pump 300, in an intermediate pumping state;

FIG. 15 is a cross-sectional illustration of a fourth exemplary embodiment of a foam pump 400, in a priming or primed state;

FIG. 16 is a cross-sectional illustration of the foam pump 400, in a final pumping state;

FIG. 17 is a cross-sectional illustration of the foam pump 400, in an intermediate pumping state; and

FIG. 18 is a cross-sectional illustration of the foam pump 400, in an intermediate pumping state.

### DETAILED DESCRIPTION

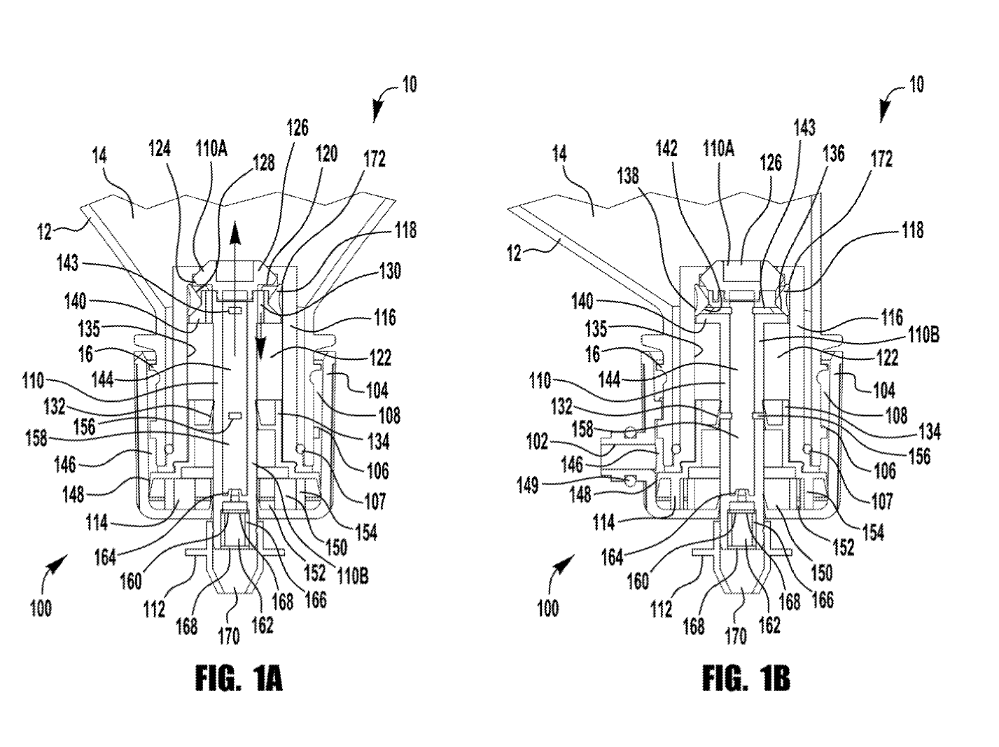

FIGS. 1A-1B, 2A-2B, 3A-3B and 4A-4B illustrate a first exemplary embodiment of a disposable refill unit 10 for use in a foam dispensing system (not shown). The disposable refill unit 10 includes a container 12 connected to a foam pump 100. The disposable refill unit 10 may be placed within a housing of the dispenser system. The foam dispenser system may be a wall-mounted system, a counter-mounted system, an un-mounted portable system movable from place to place, or any other kind of foam dispenser system.

The container 12 forms a liquid reservoir 14. The liquid reservoir 14 contains a supply of a foamable liquid within the disposable refill unit 10 and the dispensing system housing which holds the refill unit 10. In various embodiments, the contained liquid could be for example a soap, a sanitizer, a cleanser, a disinfectant or some other foamable liquid. In the exemplary refill unit 10, the liquid reservoir 14 is formed by a collapsible container, such as a flexible bag-like container. In other embodiments, the liquid reservoir 14 may be formed by a rigid housing member, or have any other suitable configuration for containing the foamable liquid without leaking. The container 12 may advantageously be refillable, replaceable, or both refillable and replaceable. In other embodiments the container 12 may be neither refillable nor replaceable.

The foam pump 100 of the disposable refill unit 10 may be releasably connected in a substantially airtight manner to an air pump (not shown) disposed within the dispensing system housing. More specifically, the pump 100 includes an air inlet 102 as shown in FIG. 1B which is connected to the air pump. In one embodiment, the air inlet 102 may be connected to the air pump with a press fit connection. In one alternative embodiment, a mechanical mechanism (not shown) may be used to mechanically releasably secure the air pump to the air inlet 102 of the foam pump 100. The air pump supplies a source of pressurized air to the air inlet 102 of the foam pump 100. As described further below, the foam pump 100 uses the pressurized air to mix with the liquid stored in the container 12 to create a foam, and then to dispense the foam. The air pump may be any means of supplying pressurized air to the air inlet 102, such as for example a bellows pump, a piston pump or a dome pump.

In one embodiment, air pump (not shown) includes an air inlet having a one-way air inlet valve therethrough. One-way air inlet valve allows air to enter air pump to recharge the air pump. In one embodiment, the air inlet is located inside of a foam dispenser housing so that air from inside of the dispenser is used to feed the air pump. Using air from inside the housing may help to prevent moisture from entering air pump through air inlet and air inlet valve. In one embodiment, a vapor barrier is provided. A vapor barrier allows air to pass through and the air inlet and enter the air pump, but prevents moisture from entering the air pump. A suitable vapor barrier is a woven one-way vapor barrier, such as, for example, Gortex®, that is arranged so that vapor does not enter air pump.

In one embodiment, the air pump includes an anti-microbial substance molded into the air pump housing. One suitable anti-microbial substance contains silver ions and or copper ions. A silver refractory, such as, for example, a glass, oxide, silver phosphate may be used. One suitable commercially available product is Ultra-Fresh, SA-18, available from Thomson Research Associates, Inc. The anti-microbial substance prevents mold or bacteria from growing inside of the air pump.

In the event the liquid stored in the reservoir 14 of the installed disposable refill unit 10 runs out, or the installed refill unit 10 otherwise has a failure, the installed refill unit 10 may be removed from the foam dispenser system. The empty or failed refill unit 10 may then be replaced with a new refill unit 10 including a liquid-filled reservoir 14. The air pump remains located within the foam dispenser system while the refill unit 10 is replaced. In one embodiment, the air pump is also removable from the housing of the dispenser system separately from the refill unit 10, so that the air pump may be replaced without replacing the dispenser, or alternatively to facilitate removal and connection to the refill unit 10. A sanitary seal 148 isolates the air pump from the portions of the foam pump 100 that contact liquid, so that the air pump mechanism does not contact liquid during operation of the foam pump 100. In a addition, a sealing member 153 seals against valve stem 110B to prevent air from leaking out around the valve stem 110B.

The housing of the dispensing system further contains one or more actuating members (not shown) to activate the foam pump 100. As will be appreciated by one of ordinary skill in the art, there are many different kinds of pump actuators which may be employed in the foam dispenser system. The pump actuator of the foam dispenser system may be any type of actuator, such as, for example, a manual lever, a manual pull bar, a manual push bar, a manual rotatable crank, an electrically activated actuator or other means for actuating the foam pump 100 within the foam dispenser system. Electronic pump actuators may additionally include a motion detector to provide for a hands-free dispenser system with touchless operation. Various intermediate linkages connect an external actuator member to the foam pump 100 within the system housing. The exemplary foam pump 100 is a “pull-activated” pump. That is, the pump 100 is actuated by pulling a valve stem 110 downwardly. The external actuator may be operated in any manner, so long as the intermediate linkages transform that motion to a downward pulling force on the valve stem 110. In one embodiment, the downward pulling force is applied to an annular member 112 of the valve stem 110.

The container 12 is connected to a pump housing 104 of the foam pump 100. The container 12 has a threaded insert neck portion 16 which is received within a mating threaded receiving portion 106 of the pump housing 104. For example, a “quarter turn” rotation may complete the connection between the threaded portions 16 and 106. An o-ring 107 or other sealing member may be included to help provide a liquid-tight sealed connection. Additional o-rings or sealing members (not shown) may be used, such as for example, between pump housing 104 and container 12. The air inlet 102 of the pump 100 is formed within the pump housing 104, to supply pressurized air from the air pump to an interior chamber 108 of the pump housing 104. In one embodiment, one or more sealing members 149, such as for example, one or more o-rings, may be used to form a seal with the air pump, or air supply line when the refill unit is placed in a dispenser.

The foam pump 100 includes several components, such as an air gasket 114, a pump body 116, the valve stem 110 and a shuttle valve 118. These pump components are at least partially held within the interior chamber 108 of the pump housing 104. When the pump housing 104 is connected to the container 12, many of the pump components also extend up into the neck portion 16 of the container 12. The valve stem 110 and the shuttle valve 118 are independently movable up and down longitudinally within the pump body 116 to move liquid through the foam pump 100, as described further below. In one embodiment, the pump housing 104 may be disposed within the neck 16 of the container 12 with external threads to secure the pump 100 to internal threads in the neck 16, and the housing 104 also may form the pump body 116.

In the particular foam pump 100 embodiment illustrated in the Figures, the valve stem 110 is composed of two separate parts 110A and 110B which snap or otherwise connect together to form the valve stem 110. This design aids the assembly process for making the pump 100. In use, the two parts 110A and 110B function as one integral part. In other embodiments, the valve stem 110 may be composed of one integral part, or three or more connected parts.

FIGS. 1A and 1B illustrate the foam pump 100 in a priming or a primed state, that is, before actuation. In that state, both the moveable valve stem 110 and the shuttle valve 118 are in their upper-most positions within the pump body 116. A liquid inlet gate valve 120 is disposed between the liquid reservoir 14 and a liquid charge chamber 122 within the pump body 116, as is best shown in FIG. 1A. The liquid inlet gate valve 120 is comprised of a first valve surface 124 formed on a top portion 126 of the movable valve stem 110, and a second valve surface 128 formed on the movable shuttle valve 118. The liquid inlet gate valve 120 opens and closes as the valve stem 110 and the shuttle valve 118 move up and down. In the priming or primed state of FIGS. 1A and 1B, the valve 120 is in an open position. In that open position, the first valve surface 124 is separated from the second valve surface 128. That separation permits liquid to be fed under the force of gravity down from the liquid container 12, through the liquid inlet gate valve 120. The valve 120 leads to one or more vertical channels 130 in the movable valve stem 110, with two such vertical channels being illustrated in the embodiment of FIG. 1A.

The liquid continues to travel under the force of gravity through the one or more vertical channels 130 down into the liquid charge chamber 122. The liquid charge chamber 122 is defined between the movable valve stem 110 on the inside and on the top, the pump body 116 on the outside, and the air gasket 114 on the bottom. The air gasket 114 has an upper wiper seal 132 which rests against the movable valve stem 110, and an annular portion 134 which fits within the pump body 116, such that a liquid-tight seal is formed at the bottom of the chamber 122. As the valve stem 110 moves up and down, the distal end portion of the upper wiper seal 132 slides up and down the exterior surface of the valve stem 110 in a liquid-tight manner. In that way, liquid stored in the liquid charge chamber 122 is prevented from escaping downwardly past the seal 132 and the annular portion 134 of the air gasket 114. Thus, when the valve stem 110 and the shuttle valve 118 are in their upper-most position as shown in FIGS. 1A and 1B, the pump 100 primes itself as liquid begins to enter the liquid charge chamber 122, and becomes fully primed when the chamber 122 is full of liquid.

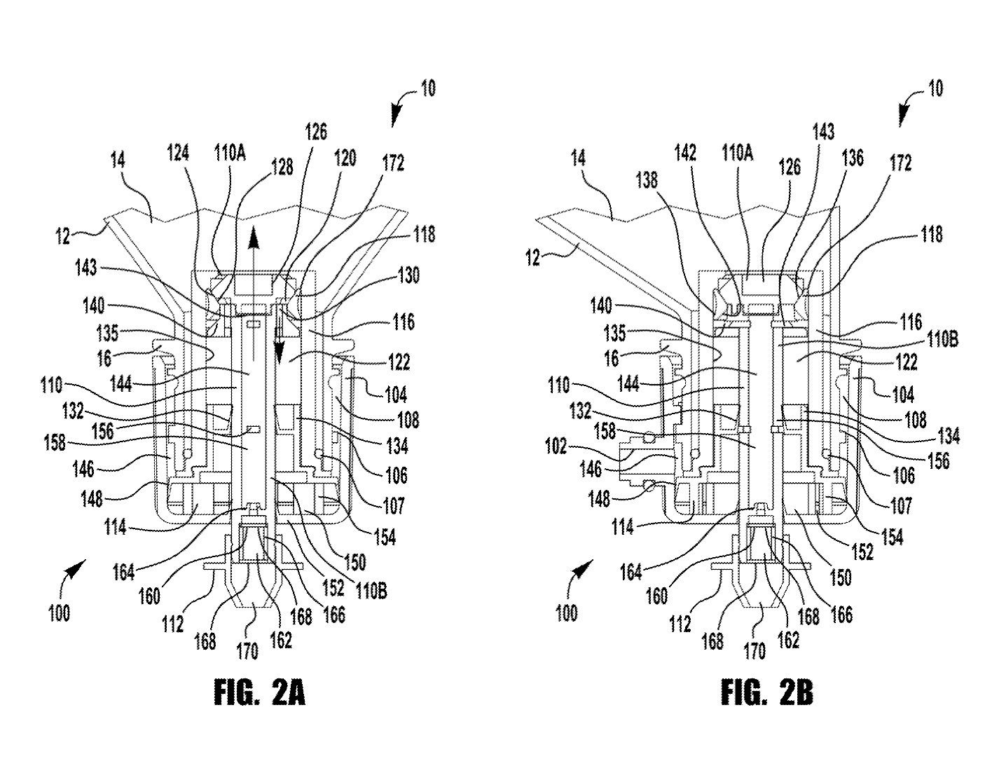

The pump 100 is actuated by the actuator (not shown) in the foam dispensing system exerting a downward pulling force on the valve stem 110, such as via the annular member 112. Initially, the frictional force between the shuttle valve 118 and an interior wall 135 of the pump body 116 prevents the shuttle valve 118 from moving downwardly with the valve stem 110. In this way, the valve stem 110 moves to the intermediate pumping state of FIGS. 2A and 2B. In that state, the underside lip of the top portion 126 has moved downwardly far enough that the first valve surface 124 contacts the second valve surface 128, as best shown in FIG. 2A. At that point, the liquid inlet gate valve 120 is closed. The contact between the top portion 126 underside lip and the shuttle valve 118 prevents liquid from flowing down out of the liquid container 12 into the vertical channels 130 and the liquid charge chamber 122. In some embodiments, the first valve surface 124 may be provided with an elastomeric member such as an o-ring in order to enhance the seal when the valve 120 is closed.

At the same time, however, a liquid outlet gate valve 136 has been opened. The liquid outlet gate valve 136 is comprised of a first valve surface 138 formed on a bottom lip annular extension 140 of the valve stem 110, and a second valve surface 142 formed on the movable shuttle valve 118. The liquid outlet gate valve 136 opens and closes as the valve stem 110 and the shuttle valve 118 move up and down. In the priming or primed state of FIG. 1B, the outlet valve 136 is in a closed position. In that closed position, the first valve surface 138 contacts the second valve surface 142. That contact prevents liquid from passing out of the liquid charge chamber 122 through the liquid outlet gate valve 136. In the intermediate pumping state of FIG. 2B, the first valve surface 138 has been separated from the second valve surface 142. That separation permits liquid to pass out of the liquid charge chamber 122 through the liquid outlet gate valve 136 and into one or more horizontal channels 143 in the valve stem 110. Two such horizontal channels 143 are illustrated in the embodiment of FIG. 2B.

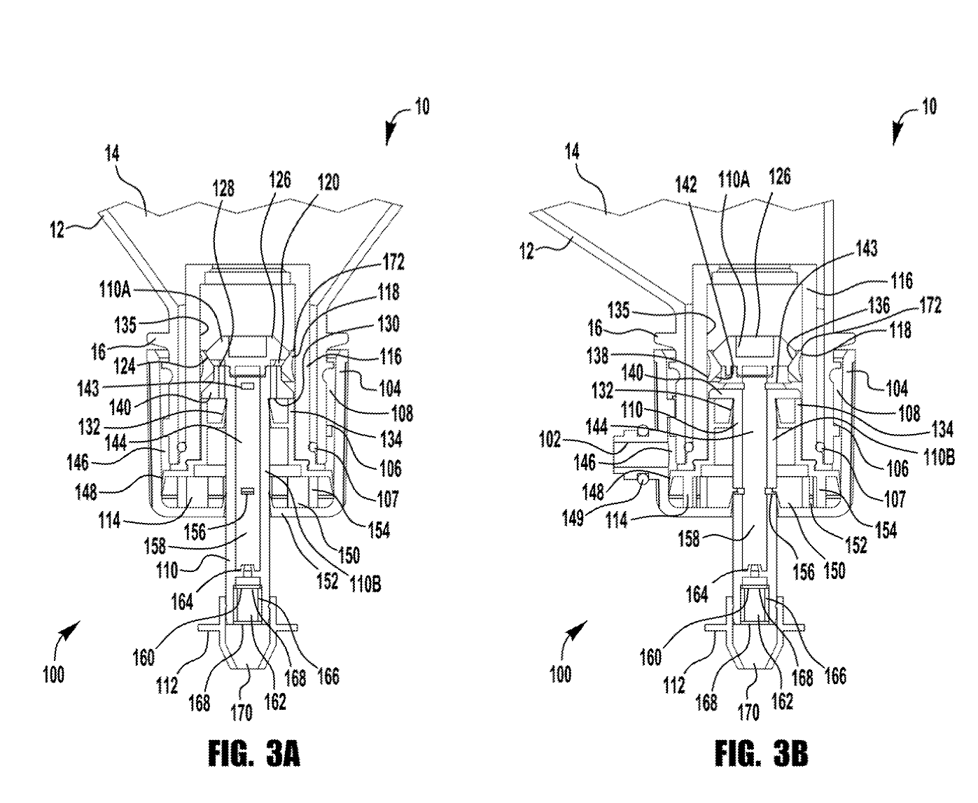

The actuator (not shown) continues to exert a downward pulling force on the valve stem 110. The interference between the top portion 126 lip of the valve stem 110 and the shuttle valve 118 overcomes the frictional force between the shuttle valve 118 and the interior wall 135 of the pump body 116. In this way, the valve stem 110 and the shuttle valve 118 move downwardly together to reach the lower-most final pumping state of FIGS. 3A and 3B. As they do so, the volume of the liquid charge chamber 122 decreases, creating a positive pressure on the liquid stored in the chamber 122. The liquid in the chamber 122 is prevented from exiting the top of the chamber 122 via the closed inlet gate valve 120, and from the bottom of the chamber 122 by the air gasket 114. Thus, the only exit path available to the liquid is the now open liquid outlet gate valve 136. As a result, during the downward stroke of the pump 100 from the intermediate state of FIGS. 2A and 2B to the final pumping state of FIGS. 3A and 3B, liquid is forced out of the liquid charge chamber 122 through the liquid outlet gate valve 136. The liquid then travels through the horizontal channels 143 which lead to a central liquid delivery conduit 144 within the valve stem 110. The foam output of the pump 100 is adjustable because the valve stem 110 can be moved to any fraction of its full stroke length which is sufficient to open the outlet gate valve 136. Moving the valve stem 110 less than a full stroke length reduces the volume of liquid pumped from the chamber 122. Accordingly, the same pump 100 may be used in different applications requiring different foam doses.

At the same time the valve stem 110 and the shuttle valve 118 are traveling downwardly, the air pump is placed in its “blow” state to deliver pressurized air to the liquid pump air inlet 102. That pressurized air enters an intermediate air chamber 146 disposed within the pump housing 104. The air gasket 114 has a lower sanitary wiper seal 148 which rests against the interior wall of the pump housing 104. The pressurized air delivered by the air pump is sufficient to overcome the lower wiper seal 148, but not the threading between the neck portion 16 and the receiving portion 106. That is, the air pressure is high enough to overcome the resiliency of the lower wiper seal 148 pressing against the interior wall of the pump housing 104, thereby separating the seal 148 from the pump housing 104. The pressurized air thus escapes from the intermediate air chamber 146 past the seal 148 and into an interior chamber 150 of the air gasket 114. Apertures 152 may be formed within an interior wall 154 of the air gasket 114 to facilitate air flow.

The pressurized air has at least one escape path from the interior chamber 150 of the air gasket 114. In one embodiment, the escape path is provided through one or more air ports 156 in the valve stem 110, leading to the liquid delivery conduit 144. Liquid flowing down the liquid delivery conduit 144 from the horizontal channels 143 mixes with the incoming air within a mixing chamber 158. In one embodiment, the chamber 158 is formed within the conduit 144.

In some embodiments, air ports 156 in the valve stem 110 may provide the sole escape path for pressurized air from the interior chamber 150 of the air gasket 114. In other embodiments, one or more additional escape paths for pressurized air may be provided. In one such embodiment, a second escape path is provided upwardly, past the upper wiper seal 132 of the air gasket 114 and into the liquid charge chamber 122. That same upward air pressure helps to prevent liquid in the liquid charge chamber 122 from escaping down into the interior chamber 150 past the seal 132, as the air travels upwardly around the seal 132. When the pressurized air enters the liquid charge chamber 122, it helps to force the liquid stored therein out of the chamber 122 through the liquid outlet gate valve 136 and down the delivery conduit 144 to the mixing chamber 158.

The incoming air pressure though the air ports 156 in the valve stem 110 helps to prevent liquid and foam in the mixing chamber 158 from escaping through the air ports 156 into the interior chamber 150. In the mixing chamber 158, the foamable liquid moving down the liquid delivery conduit 144 and the pressurized air arriving from the air ports 156 mix together in a swirling motion to form a mixture. Thus, the liquid-air mixture within the mixing chamber 158 is forced by gravity and the incoming air pressure within the liquid delivery conduit 144 into an inlet 160 of a foaming chamber 162.

In some embodiments, a drip catch 164 may be formed within the conduit 144 between the mixing chamber 158 and the foaming chamber 162. Such a drip catch 164 operates to prevent leakage between pumping actuations by catching fluid and/or foam which remains within the mixing chamber 158 after the pump 100 actuation is complete.

Within the foaming chamber 162, the liquid-air mixture is enhanced into a rich foam. For example, the foaming chamber 162 may house one or more foaming elements therein. Suitable foaming elements include, for example, one or more screens, meshes, porous membranes or sponges. In addition, one or more of such foaming element(s) may be disposed in a foaming cartridge within the foaming chamber 162. The foam pump 100, for example, has a foaming cartridge 166 with two screen foaming elements 168. As the liquid/air mixture passes through the foaming element(s), the mixture is turned into an enhanced foam. In some embodiments, the mixing and foaming action may both occur in one single chamber, which is then both a mixing chamber and a foaming chamber. The foam is dispensed from the foaming chamber 162 through a foam outlet 170.

In some embodiments, the foam outlet 170 is simply an aperture leading from the foaming chamber 162 directly to the outside atmosphere surrounding the foam dispenser system. In other embodiments, the foam outlet 170 may optionally include tubing or other delivery conduits (not shown) to carry the foam from the foaming chamber 162 to such an aperture. In additional embodiments, the foam outlet 170 may optionally include one or more one-way check valves (not shown) to prevent back flow of foam from the foam outlet 170 into the foaming chamber 162 or to prevent unwanted liquid or foam discharge while the dispenser is not being used. Suitable one-way check valves may include a flapper valve, a conical valve, a plug valve, an umbrella valve, a duck-bill valve, a ball valve, a slit valve, a mushroom valve, a spring and ball valve, or any other one-way check valve. Similar one-way check valves may optionally be placed in other portions of the liquid delivery path from the liquid reservoir 14 to the mixing chamber 158 and then to the foam outlet 170, as desirable or necessary. They may, for example, be placed in the air ports 156 to help prevent liquid from escaping the liquid delivery conduit 144.

In a preferred embodiment, the air to liquid ratio in the mixture formed in the mixing chamber 158 is approximately 10:1, but any ratio may be provided. The air to liquid ratio is determined by the volume and pressure of the air being delivered by the air pump, and the amount of liquid entering the mixing chamber 158 from the liquid delivery conduit 144. Once these and other applicable design variables are chosen to provide the desired air to liquid ratio, a consistently accurate dosing is thereafter provided. For example, a pressurized air escape path through the liquid charge chamber 122 as described above may be an additional means of controlling the air to liquid ratio by controlling the quantity of pressurized air that is delivered to the liquid charge chamber 122. The volume of liquid may also be varied by adjusting the stroke of the valve stem 110.

The valve stem 110 and the shuttle valve 118 move downward until they stop. FIGS. 3A and 3B illustrate a lower-most position, wherein further downward movement is prevented by interference between the annular extension 140 of the valve stem 110 and the annular portion 134 of the air gasket 114. That position represents the maximum pumping stroke of the valve stem 110, producing the maximum amount of foam. The pumping actuator of the system may, however, stop the downward movement before that maximum displacement is reached, to reduce the amount of foam dispensed as desired by the user.

Regardless of the length of the pumping stroke, when downward movement of the valve stem 110 and the shuttle valve 118 stops, the foaming and pumping actions also stop. The relative positions of the valve stem 110 and the shuttle valve 118 will then be as shown in FIGS. 3A and 3B. In that configuration, the liquid inlet gate valve 120 is closed and the liquid outlet gate valve 136 is open.

At that time, a restoring force pushes the valve stem 110 to move upwardly within the pump body 116. The restoring force may be provided, for example, by a compressed coil spring (not shown) pushing up on the annular member 112. Such a coil spring may alternatively or additionally be provided within the liquid charge chamber 122, for example. In such embodiments, the downward force provided by the pump actuator overcomes the upward bias of the coil spring(s) in order to perform the pumping action illustrated by FIGS. 1A-1B, 2A-2B and 3A-3C. Then the downward actuating force is removed, permitting the coil spring(s) to push the valve stem 110 upwardly. The restoring force may alternatively or additionally be provided by the actuator itself exerting an upward force on the valve stem 110, such as via the annular member 112.

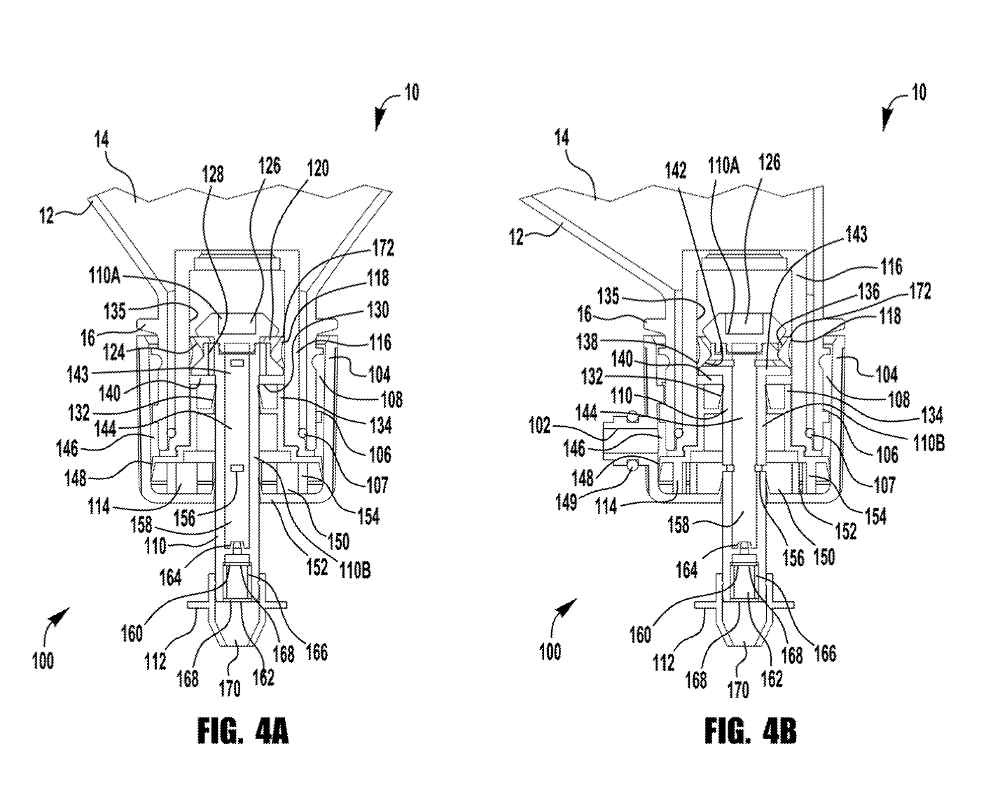

As the valve stem 110 initially begins its upward travel, the frictional force between the shuttle valve 118 and the interior wall 135 of the pump body 116 prevents the shuttle valve 118 from moving upwardly with the valve stem 110. In this way, the pump 100 moves to the intermediate pumping state of FIGS. 4A and 4B. In that state, the top portion 126 of the valve stem 110 has moved upwardly far enough that the first valve surface 124 is separated from the second valve surface 128, as best shown in FIG. 4A. Therefore, at that point, the liquid inlet gate valve 120 is open and the liquid outlet gate valve 136 is closed. The liquid outlet gate valve 136 becomes closed when the first valve surface 138 contacts the second valve surface 142, preventing liquid from passing out of the liquid charge chamber 122 into the horizontal channels 143, as best shown in FIG. 4B.

The restoring force continues to exert an upward pushing force on the valve stem 110. The interference between the bottom lip annular extension 140 of the valve stem 110 and the shuttle valve 118 overcomes the frictional force between the shuttle valve 118 and the interior wall 135 of the pump body 116. In this way, the valve stem 110 and the shuttle valve 118 move upwardly together to reach the upper-most priming or primed state of FIGS. 1A and 1B. At that point further upward movement is prevented by interference between the shuttle valve 118 and an inset portion 172 of the pump housing 104.

As the valve stem 110 and the shuttle valve 118 move upwardly, the volume of the liquid charge chamber 122 increases. Liquid stored in the liquid reservoir 14 is free to move down into the liquid charge chamber 122 through the open liquid inlet gate valve 120. It does so not only under the force of gravity, but also by the negative hydraulic pressure generated by the sealed (other than the open valve 120) chamber 122. The closed liquid outlet gate valve 136 prevents the liquid from exiting the chamber 122. During the upward stroke of the valve stem 110 and the shuttle valve 118, the air pump may be turned “off” to stop its delivery of pressurized air. Thus, liquid will continue to fill the chamber 122 until it is full, readying the pump 100 for another actuation.

During operation of the foam pump 100, the air pump (not shown) preferably remains dry or free from liquids and foamy mixtures, to prevent bacteria from growing in the air pump. This is accomplished by the seal 148 which is a sanitary seal in that it prevents liquid and foam from contaminating the air pump or coming into contact with elements of the foam dispenser system that are located outside of the intended liquid and foam delivery path. Optionally, one-way valves as discussed above may be added to the air ports 156 to further ensure that liquid does not contaminate the air pump.

The disposable refill unit including the wet portions of the foam pump 100 has many advantages. Among them is the ease by which the unit may be prepared for shipping and delivery to an end user location, without leakage. If the unit 10 is packed with the valve stem 110 held in the uppermost position of FIGS. 1A and 1B, the liquid inlet gate valve 120 will correspondingly be held closed to prevent liquid from escaping the reservoir 14. This can easily be accomplished with appropriate packaging materials. It has the added benefit of keeping the unit 10 in its smallest size configuration during shipping.

Indeed, another potential benefit provided by the foam pump 100 is that it may be used to provide a small pump mechanism. This size advantage arises, in part, because many of the foam pump 100 components extend up into the neck 16 of the container 12. And, in some cases the diameter of the foam screens 168 may be no more than about 0.6″ in diameter. Further, in one embodiment, substantially all of the working components of the pump 100 are located within the neck 16 of the container 12. For example, at least fifty percent (50%) of the pump components may fit wholly or partly within the neck portion 16.

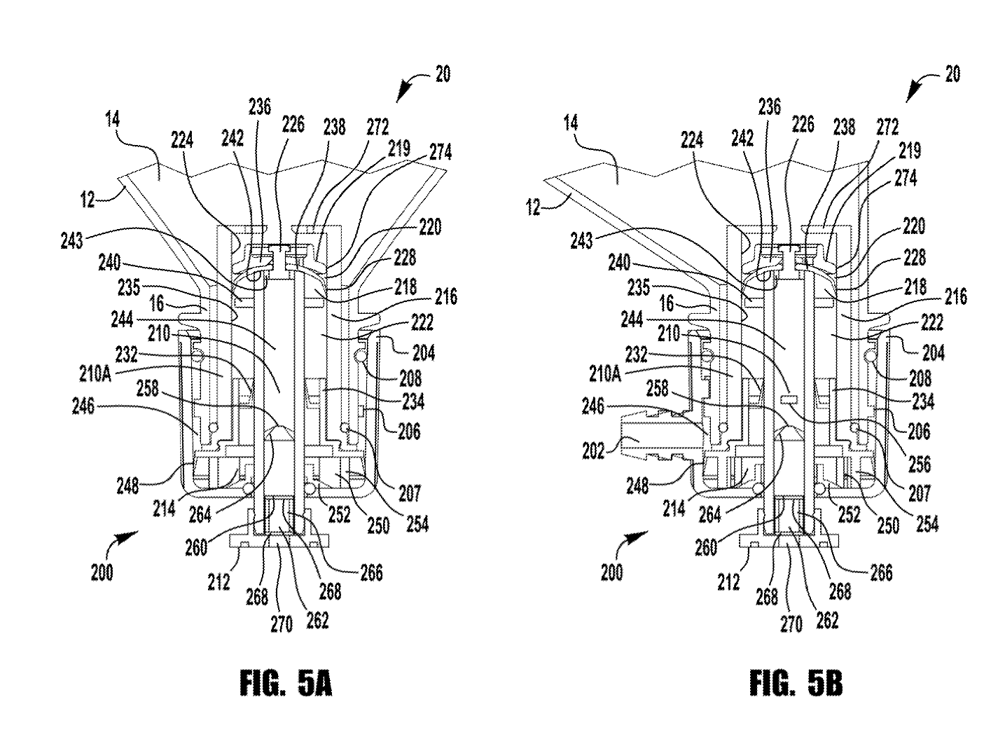

FIGS. 5A-5B, 6A-6B, 7A-7B and 8A-8B illustrate a second exemplary embodiment of a foam pump 200. The foam pump 200 may be used with the same container 12 as the first exemplary foam pump 100 to form a disposable refill unit 20 for use in a foam dispensing system (not shown). The foam pump 200 connects to and operates with the container 12 in the same way as the foam pump 100. Therefore, a detailed discussion of the container 12 and the overall foam dispensing system is omitted here, having already been described above.

The foam pump 200 includes many components which are identical to, or at least perform similar functions as, corresponding components within the foam pump 100. Such components are identified by reference numerals having a different leading digit but the same final two digits. Thus, for example, the foam pump 200 has an air inlet 202 and a pump housing 204 which are substantially identical to the air inlet 102 and the pump housing 104 of the foam pump 100. The foam pump 200 also has a moveable valve stem 210 which performs a similar function to the valve stem 110 of the foam pump 100, but in some respects the two valve stems 110, 210 are structurally different.

The components of the foam pump 200 include an air gasket 214, a pump body 216, the valve stem 210, a flexible disk valve 218 and a guide disk 219. The guide disk 219 may be rigid. Many of these pump components are at least partially held within the interior chamber 208 of the pump housing 204. When the pump housing 204 is connected to the container 12, many of the pump components also extend up into the neck 16 of the container 12. In one embodiment, the pump housing 204 may be disposed within the neck 16 of the container 12 with external threads to secure the pump 200 to internal threads in the neck 16.

The valve stem 210 moves up and down longitudinally within the pump body 216 to move liquid through the foam pump 200, as described further below. In the particular foam pump 200 embodiment illustrated in the Figures, the valve stem 210 is composed of a central stem part 210A and the guide disk 219, which snap or otherwise connect together to form the valve stem 210. This design aids the assembly process for making the pump 200. In use, the two parts 210A and 219 function as one integral part. In other embodiments, the valve stem 210 may be composed of one integral part, or three or more connected parts.

The flexible disk valve 218 and the guide disk 219 are attached to the central stem part 210A. More specifically, the central stem part 210A has a top portion 226 with a reduced diameter section receiving the disk valve 218 and the guide disk 219 via central apertures in those disks. The top portion 226 has an enlarged diameter section above its reduced diameter section to hold the disk valve 218 and the guide disk 219 in place. In that way, the disk valve 218 and the guide disk 219 move up and down with the central stem part 210A longitudinally within the pump body 216. The disk valve 218 and the guide disk 219 may be made from materials which are flexible enough to receive the enlarged diameter section of the top portion 226 during the assembly process. Alternatively, the central stem part 210A may be composed of two parts which connect together around the disk valve 218 and the guide disk 219 during the assembly process. In yet another potential embodiment, the disk valve 218 and the guide disk 219 may be formed integrally with the central stem part 210A, but having relative widths or other characteristics so that they perform as described below.

The disk valve 218 is made from a flexible and resilient material, such as a thermoplastic rubber, a chemical resistant elastomeric polymer, such as, for example, thermoplastic rubber, TPV, silicone, trade name ENGAGE, urethane, a BoPet film, such as Mylar of less than 0.30″ thick. It flexes up and down, as described further below, as the valve stem 210 moves up and down in order to operate the foam pump 200. The outer edge of the disk valve 218 comprises a wiper seal which rests against the interior wall 235 of the pump body 216. As the valve stem 210 moves up and down, the outer wiper seal moves up and down the interior wall 235 of the pump body 216.

In one embodiment, the guide disk 219 is more rigid than the flexible disk valve 218, due to its material characteristics or relative thickness. Chemical resistant low friction rigid plastics, such as, for example Polypro, HDPE, LDPE, Acetal and Nylon may be useful materials for making the flexible disk. The guide disk 219 forms one or more liquid pathways through or past the guide disk. For example, the guide disk 219 may have apertures and/or castellated indentations 274 around its periphery, to help promote the flow of liquid from the container 12 through or around the guide disk 219 and down into a liquid charge chamber 222. The guide disk 219 may alternatively or additionally have an outer diameter which is small enough to permit liquid to flow around the disk 219 within the cavity of the pump body 216 as another type of liquid pathway past the guide disk 219. Some embodiments may forego a guide disk 219, instead having only a disk valve 218 mounted on the valve stem 210. In such a case the disk valve 218 could have a thick base so that the valve 218 would not invert during a pumping action.

FIGS. 5A and 5B illustrate the foam pump 200 in a priming or a primed state, that is, before actuation. In that state, the moveable valve stem 210 and the flexible disk valve 218 are in their upper-most positions within the pump body 216. A liquid inlet gate valve 220 is disposed between the liquid reservoir 14 and the liquid charge chamber 222 within the pump body 216. In one embodiment, the liquid inlet gate valve 220 is a wiper seal. The liquid inlet gate valve 220 is comprised of a first valve surface 224 formed on the interior wall 235 of the pump body 216, and a second valve surface 228 formed on the outer wiper seal of the flexible disk valve 218. The liquid inlet gate valve 220 opens and closes as the valve stem 210 and the flexible disk valve 218 move up and down within the pump body 216. In the priming or primed state of FIGS. 5A and 5B, the valve 220 is in a closed position. In that closed position, the first valve surface 224 contacts the second valve surface 228. The contact between the two valve surfaces 224 and 228 prevents liquid from passing through the inlet gate valve 220.

The liquid inlet gate valve 220 may be opened in any one of a number of fashions. In one embodiment, the force of gravity of the liquid stored in the container 12 by itself is sufficient to separate the two valve surfaces 224 and 228 to open the valve 220. Such separation permits liquid to be fed under the force of gravity down from the liquid container 12 through the liquid inlet gate valve 220. The valve 220 then closes when the liquid charge chamber 222 is full of liquid. In another embodiment, the resiliency of the flexible disk valve 218 is such that the force of gravity of the liquid in the container 12 by itself is not sufficient to open the valve 220. In such an embodiment, the negative hydraulic pressure formed within the chamber 222 during an upward stroke of the valve stem 210 and the flexible disk valve 218 (as discussed below) separates or aids in the separation of the two valve surfaces 224 and 228 to open the valve 220.

The liquid charge chamber 222 is defined between the movable valve stem 210 on the inside, the flexible disk valve 218 on the top, the pump body 216 on the outside, and the air gasket 214 on the bottom. The air gasket 214 has an upper wiper seal 232 which rests against the movable valve stem 210, and an annular portion 234 which fits within the pump body 216, such that a liquid-tight seal is formed at the bottom of the chamber 222. As the valve stem 210 moves up and down, the distal end portion of the upper wiper seal 232 slides up and down the exterior surface of the valve stem 210 in a liquid-tight manner. In that way, liquid stored in the liquid charge chamber 222 is prevented from escaping downwardly past the seal 232 and the annular portion 234 of the air gasket 214. Thus, when the valve stem 210 and the flexible disk valve 218 are moving to or in their upper-most position as shown in FIGS. 5A and 5B, the pump 200 primes itself as liquid begins to enter the liquid charge chamber 222 and becomes fully primed when the chamber 222 is full of liquid.

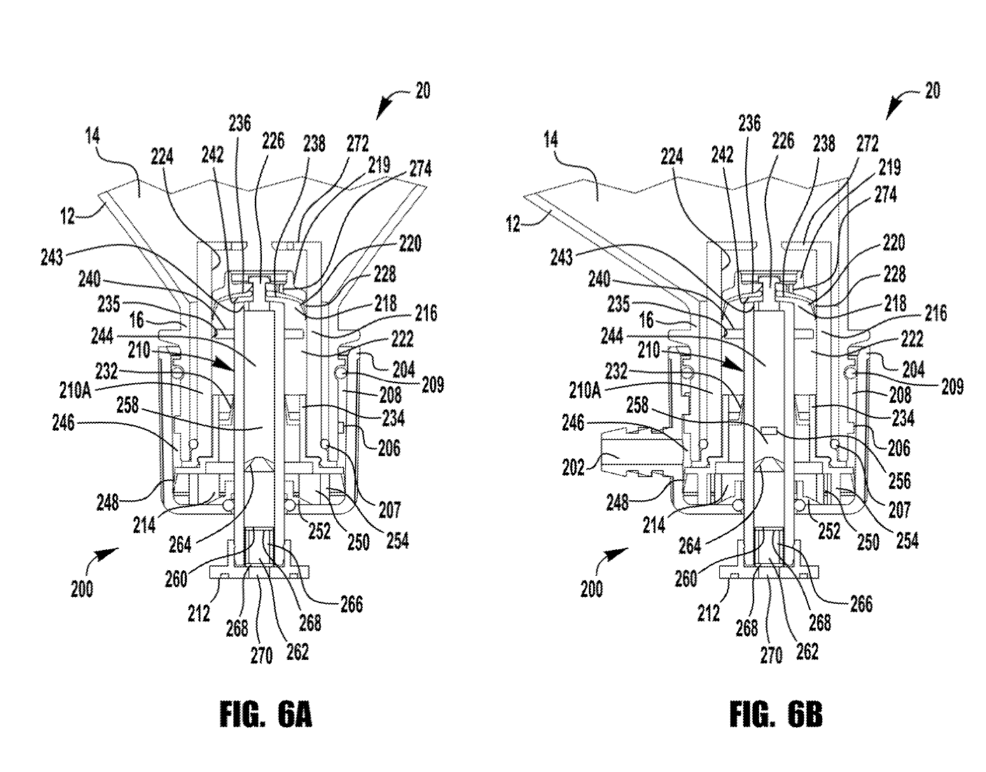

The pump 200 is actuated by the actuator (not shown) in the foam dispensing system exerting a downward pulling force on the valve stem 210. In one embodiment, the downward pulling force is applied to an annular member 212. Initially, the frictional force between the flexible disk valve 218 and the interior wall 235 of the pump body 216 causes the flexible disk valve 218 to flex upwardly. In this way, the pump 200 moves to the intermediate pumping state of FIGS. 6A and 6B. As the valve stem 210 and the flexible disk valve 218 continue to move downwardly together within the pump body 216, the flexible disk valve 218 will continue to hold its upwardly flexed position relative to the valve stem 210 as shown in those Figures. At the same time, the volume of the liquid charge chamber 222 decreases, creating a positive pressure on the liquid stored in the chamber 222. These effects combine to produce at least two results during a downward stroke of the valve stem 210 and flexible disk valve 218.

First, the liquid inlet gate valve 220 is held closed by hydraulic pressure, despite the force of gravity from the liquid in the container 12 urging the valve 220 to open. At the top of the liquid charge chamber 222, the hydraulic pressure within the chamber 222 increases the force acting to press the outer wiper seal of the flexible disk valve 218 against the interior wall 235 of the pump body 216. The contact between the two valve surfaces 224 and 228 prevents liquid from being fed under the force of gravity down from the liquid container 12 into the liquid charge chamber 222. In embodiments having a guide disk 219 above the flexible disk valve 218, the guide disk 219 may provide a firm support for shaping the flexible disk valve 218 in a closed position. Thus, during a downward stroke of the valve stem 210 and the flexible disk 218, the liquid inlet gate valve 220 is closed.

Second, the downward movement of the valve stem 210 and the flexible disk 218 opens a liquid outlet gate valve 236. The liquid outlet gate valve 236 is comprised of a first valve surface 238 formed on the valve stem 210, and a second valve surface 242 formed on the flexible disk valve 218. In the priming or primed state of FIG. 5B, the outlet valve 236 is in a closed position. In that closed position, the first valve surface 238 contacts the second valve surface 242. That contact prevents liquid from passing out of the liquid charge chamber 222 through the liquid outlet gate valve 236. In the intermediate pumping state of FIGS. 6A and 6B, the upward flexing of the flexible disk valve 218 has separated the first valve surface 238 from the second valve surface 242. That separation permits liquid to pass out of the liquid charge chamber 222 through the liquid outlet gate valve 236 and into one or more channels 243 in the valve stem 210. Two such channels 243 are illustrated in the embodiment of FIG. 6A.

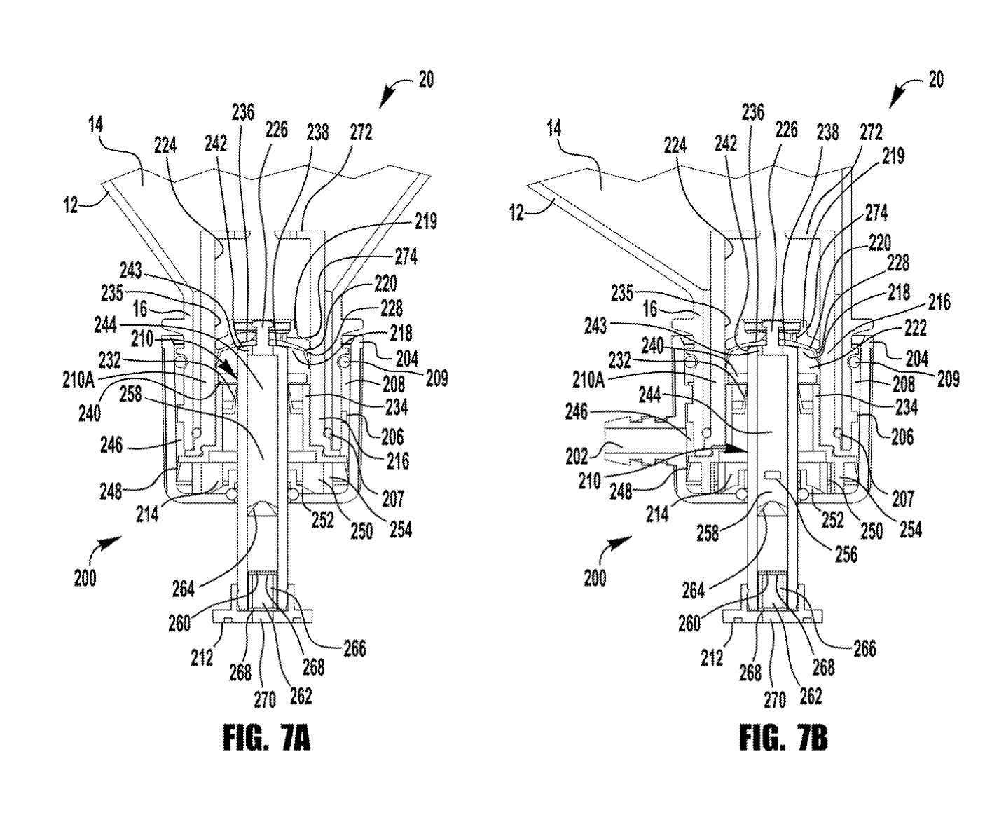

The liquid in the chamber 222 is prevented from exiting the top of the chamber 222 via the closed inlet gate valve 220, and from exiting the bottom of the chamber 222 by the air gasket 214. Thus, the only exit path available to the liquid is the now open liquid outlet gate valve 236. As a result, during the downward stroke of the pump 200 moving it from the intermediate state of FIGS. 6A and 6B to the final pumping state of FIGS. 7A and 7B, liquid is forced out of the liquid charge chamber 222 through the liquid outlet gate valve 236 by a positive hydraulic pressure. The liquid then travels through the channels 243 which lead to a central liquid delivery conduit 244 within the valve stem 210. The foam output of the pump 200 is adjustable because the valve stem 210 can be moved to any fraction of its full stroke length which is sufficient to open the outlet gate valve 236. Moving the valve stem 210 less than a full stroke length reduces the volume of liquid pumped from the chamber 222. Accordingly, the same pump 200 may be used in different applications requiring different foam doses.

At the same time the valve stem 210 and the flexible disk valve 218 are traveling downwardly, the air pump is placed in its “blow” state to deliver pressurized air to the liquid pump air inlet 202. That pressurized air enters an intermediate air chamber 246 disposed within the pump housing 204. The air gasket 214 has a lower sanitary wiper seal 248 which rests against the interior wall of the pump housing 204. The pressurized air delivered by the air pump is sufficient to overcome the lower wiper seal 248, but not the threading between the neck portion 16 and the receiving portion 206. That is, the air pressure is high enough to overcome the resiliency of the lower wiper seal 248 pressing against the interior wall of the pump housing 204, thereby separating the seal 248 from the pump housing 204. The pressurized air thus escapes from the intermediate air chamber 246 past the seal 248 and into an interior chamber 250 of the air gasket 214. Apertures 252 may be formed within an interior wall 254 of the air gasket 214 to facilitate air flow. In a addition, a sealing member 253 seals against valve stem 210 to prevent air from leaking out around the valve stem 210.

The pressurized air has at least one escape path from the interior chamber 250 of the air gasket 214. In one embodiment, the escape path is provided through one or more air ports 256 in the valve stem 210, leading to the liquid delivery conduit 244. Liquid flowing down the liquid delivery conduit 244 from the channels 243 mixes with the incoming air within a mixing chamber 258. In one embodiment, the chamber 258 is formed within the conduit 244.

In some embodiments, air ports 256 in the valve stem 210 may provide the sole escape path for pressurized air from the interior chamber 250 of the air gasket 214. In other embodiments, one or more additional escape paths for pressurized air may be provided. In one such embodiment, a second escape path is provided upwardly, past the upper wiper seal 232 of the air gasket 214 and into the liquid charge chamber 222. That same upward air pressure helps to prevent liquid in the liquid charge chamber 222 from escaping down into the interior chamber 250 past the seal 232, as the air travels upwardly around the seal 232. When the pressurized air enters the liquid charge chamber 222, it helps to force the liquid stored therein out of the chamber 222 through the liquid outlet gate valve 236 and down the delivery conduit 244 to the mixing chamber 258.

The incoming air pressure though the air ports 256 in the valve stem 210 helps to prevent liquid and foam in the mixing chamber 258 from escaping through the air ports 256 into the interior chamber 250. In the mixing chamber 258, the foamable liquid moving down the liquid delivery conduit 244 and the pressurized air arriving from the air ports 256 mix together in a swirling motion to form a mixture. Thus, the liquid-air mixture within the mixing chamber 258 is forced by gravity and the incoming air pressure within the liquid delivery conduit 244 into an inlet 260 of a foaming chamber 262.

In some embodiments, a drip catch 264 may be formed within the conduit 244 between the mixing chamber 258 and the foaming chamber 262. Such a drip catch 264 operates to prevent leakage between pumping actuations by catching fluid and/or foam which remains within the mixing chamber 258 after the pump 200 actuation is complete.

Within the foaming chamber 262, the liquid-air mixture is enhanced into a rich foam. For example, the foaming chamber 262 may house one or more foaming elements therein. Suitable foaming elements include, for example, one or more screens, meshes, porous membranes or sponges. In addition, one or more of such foaming element(s) may be disposed in a foaming cartridge within the foaming chamber 262. The foam pump 200, for example, has a foaming cartridge 266 with two screen foaming elements 268. As the liquid/air mixture passes through the foaming element(s), the mixture is turned into an enhanced foam. In some embodiments, the mixing and foaming action may both occur in one single chamber, which is then both a mixing chamber and a foaming chamber. The foam is dispensed from the foaming chamber 262 through a foam outlet 270.

In some embodiments, the foam outlet 270 is simply an aperture leading from the foaming chamber 262 directly to the outside atmosphere surrounding the foam dispenser system. In other embodiments, the foam outlet 270 may optionally include tubing or other delivery conduits (not shown) to carry the foam from the foaming chamber 262 to such an aperture. In additional embodiments, the foam outlet 270 may optionally include one or more one-way check valves (not shown) to prevent back flow of foam from the foam outlet 270 into the foaming chamber 262 or to prevent unwanted liquid or foam discharge while the dispenser is not being used. Suitable one-way check valves may include a flapper valve, a conical valve, a plug valve, an umbrella valve, a duck-bill valve, a ball valve, a slit valve, a mushroom valve, a spring and ball valve, or any other one-way check valve. Similar one-way check valves may optionally be placed in other portions of the liquid delivery path from the liquid reservoir 14 to the mixing chamber 258 and then to the foam outlet 270, as desirable or necessary. They may, for example, be placed in the air ports 256 help prevent liquid from escaping the liquid delivery conduit 244.

In a preferred embodiment, the air to liquid ratio in the mixture formed in the mixing chamber 258 is approximately 10:1, but any ratio may be provided. The air to liquid ratio is determined by the volume and pressure of the air being delivered by the air pump, and the amount of liquid entering the mixing chamber 258 from the liquid delivery conduit 244. Once these and other applicable design variables are chosen to provide the desired air to liquid ratio, a consistently accurate dosing is thereafter provided. For example, a pressurized air escape path through the liquid charge chamber 222 as described above may be an additional means of controlling the air to liquid ratio by controlling the quantity of pressurized air that is delivered to the liquid charge chamber 222. The volume of liquid may be varied by adjusting the stroke of the valve stem 210.

The valve stem 210 and the flexible disk valve 218 move downward until they stop. FIGS. 7A and 7B illustrate the lower-most position, wherein further downward movement is prevented by interference between an annular extension 240 of the valve stem 210 and the annular portion 234 of the air gasket 214. That position represents the maximum pumping stroke of the valve stem 210, producing the maximum amount of foam. The pumping actuator of the system may, however, stop the downward movement before that maximum displacement is reached, to reduce the amount of foam dispensed as desired by the user.

Regardless of the length of the pumping stroke, when downward movement of the valve stem 210 and the flexible disk valve 218 stops, the foaming and pumping actions also stop. The relative positions of the valve stem 210 and the flexible disk valve 218 will then be as shown in FIGS. 7A and 7B. In that configuration, the liquid inlet gate valve 220 is closed and the liquid outlet gate valve 236 is open.

At that time, a restoring force pushes the valve stem 210 to move upwardly within the pump body 216. The restoring force may be provided, for example, by a compressed coil spring (not shown) pushing up on the annular member 212. Such a coil spring may alternatively or additionally be provided within the liquid charge chamber 222, for example. In such embodiments, the downward force provided by the pump actuator overcomes the upward bias of the coil spring(s) in order to perform the pumping action illustrated by FIGS. 5A-5B, 6A-6B and 7A-7B. Then the downward actuating force is removed, permitting the coil spring(s) to push the valve stem 210 upwardly. The restoring force may alternatively or additionally be provided by the actuator itself exerting an upward force on the valve stem 210, such as via the annular member 212.

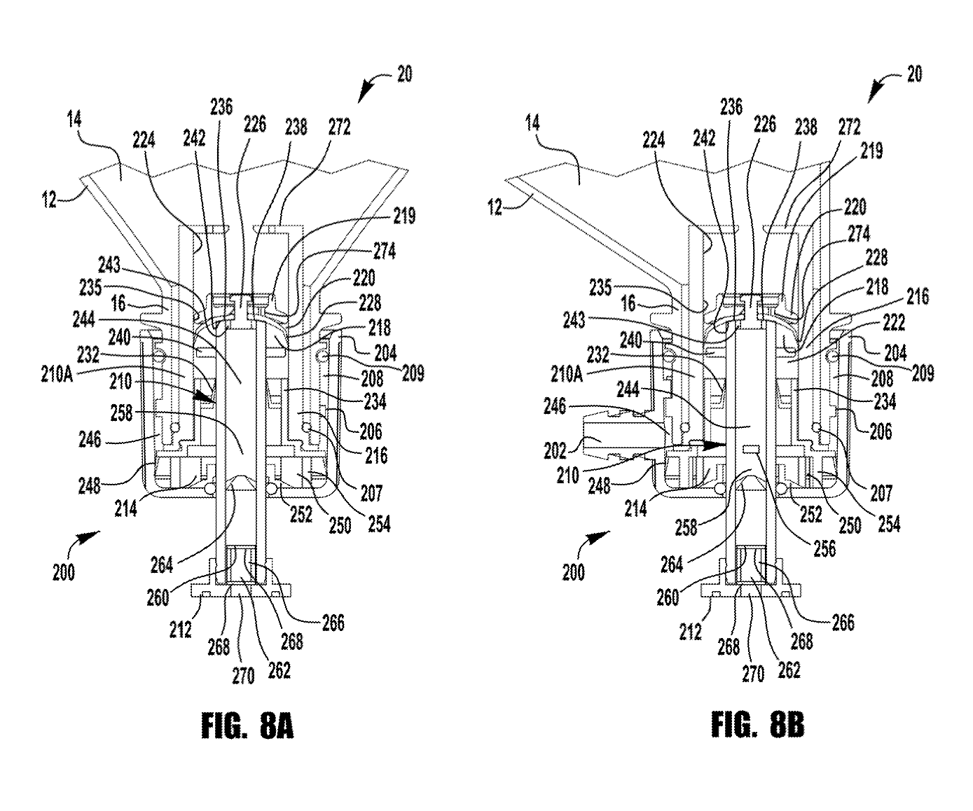

As the valve stem 210 and the flexible valve disk 218 initially begin their upward travel, the forces previously acting to hold the flexible valve disk 218 in the upwardly flexed position of FIGS. 7A and 7B are removed. In this way, the pump 200 moves to the intermediate pumping state of FIGS. 8A and 8B. In that state, the valve stem 210 has moved upwardly far enough that the flexible disk valve 218 has moved back to its rest position. As will be appreciated, in that position, the liquid outlet gate valve 236 is closed by the first valve surface 238 contacting the second valve surface 242, preventing liquid from passing out of the liquid charge chamber 222 into the channels 243.

The restoring force continues to exert an upward pushing force on the valve stem 210 and the flexible disk valve 218. At this point the liquid inlet gate valve 220 may be opened by separation of the first valve surface 224 from the second valve surface 228. Such separation may be caused solely by the force of gravity from the liquid in the container 12 acting on the flexible disk valve 218. It may also be aided by a hydraulic force acting within the liquid charge chamber 222. That is, as the valve stem 210 and the flexible disk valve 218 move upwardly, the volume of the liquid charge chamber 222 increases. The chamber 222 is sealed closed at the outlet gate valve 236 and at the air gasket 214. Thus, the increasing volume of the chamber 222 creates a negative hydraulic force acting to open the inlet gate valve 220 and pull liquid into the chamber 222. During the upward stroke of the valve stem 210 and the flexible disk valve 218, the air pump may be turned “off” to stop its delivery of pressurized air. Thus, liquid will continue to fill the chamber 222 until it is full, readying the pump 200 for another actuation.

In this way, the valve stem 210 and the flexible disk valve 218 move upwardly together to reach the upper-most priming or primed state of FIGS. 5A and 5B. At that point further upward movement is prevented by interference between the flexible disk valve 218, or the guide disk 219 if present, and an inset portion 272 of the pump housing 204.

During operation of the foam pump 200, the air pump (not shown) preferably remains dry or free from liquids and foamy mixtures, to prevent bacteria from growing in the air pump. This is accomplished by the seal 248 which is a sanitary seal in that it prevents liquid and foam from contaminating the air pump or coming into contact with elements of the foam dispenser system that are located outside of the intended liquid and foam delivery path. Optionally, one-way valves as discussed above may be added to the air ports 256 to further ensure that liquid does not contaminate the air pump.

The disposable refill unit including the wet portions of the foam pump 200 has many advantages. Among them is the ease by which the unit may be prepared for shipping and delivery to an end user location, without leakage. If the unit 20 is packed with the valve stem 210 held in the uppermost position of FIGS. 5A and 5B, the liquid inlet gate valve 220 will correspondingly be held closed to prevent liquid from escaping the reservoir 14. This can easily be accomplished with appropriate packaging materials. It has the added benefit of keeping the unit 20 in its smallest size configuration during shipping.

Indeed, another potential benefit provided by the foam pump 200 is that it may be used to provide a small pump mechanism. This size advantage arises, in part, because many of the foam pump 200 components extend up into the neck 16 of the container 12. And, in some cases the diameter of the foam screens 268 may be no more than about 0.06″ in diameter. Further, in one embodiment, substantially all of the working components of the pump 200 are located within the neck 16 of the container 12. For example, at least fifty percent (50%) of the pump components may fit wholly or partly within the neck portion 16.

Yet an additional benefit which may be provided by the foam pump 200 is that it has very few working parts, relative to many past pump designs. Thus the pump 200 provides very little resistance to the flow of liquid through it, and may be relatively less expensive to manufacture.

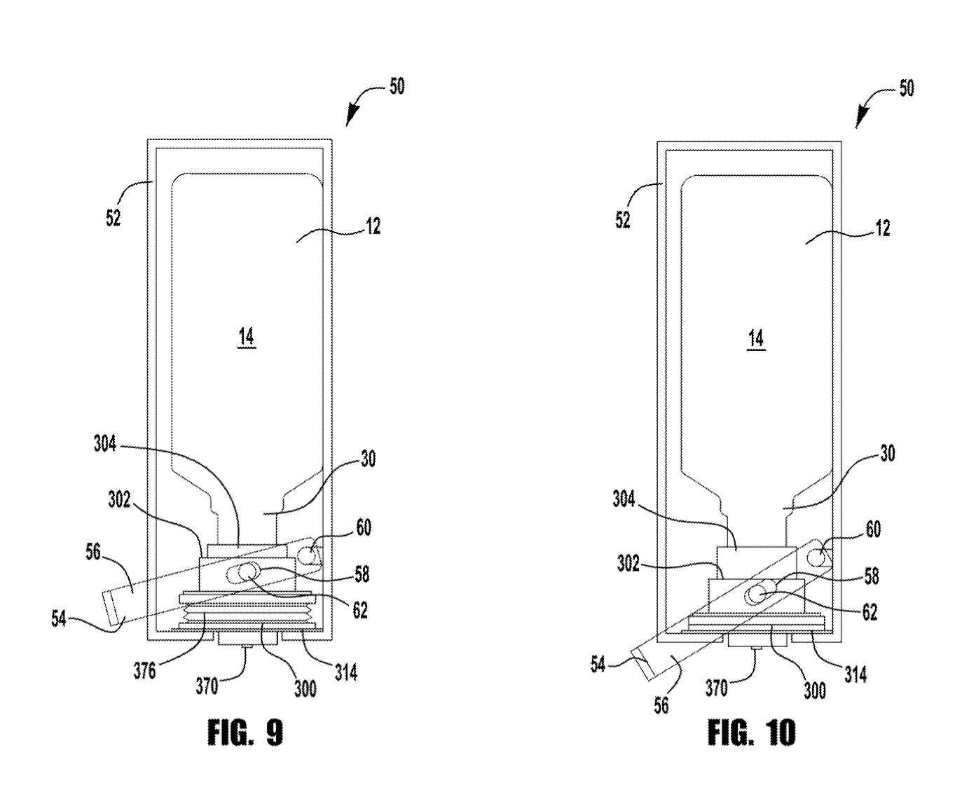

FIGS. 9-14 illustrate a third exemplary embodiment of a disposable refill unit 30, for use for example in a foam dispenser system 50. Referring initially to FIGS. 9 and 10, the disposable refill unit 30 includes a container 12 connected to a foam pump 300. The disposable refill unit 30 may be placed within a housing 52 of the dispenser system 50. The foam dispenser system 50 is a wall-mounted system. The foam pump 300 may alternatively be used in a counter-mounted system, an un-mounted portable system movable from place to place, or any other kind of foam dispenser system.

The container 12 forms a liquid reservoir 14. The liquid reservoir 14 contains a supply of a foamable liquid within the disposable refill unit 30 and the dispensing system housing 52 which holds the refill unit 30. In various embodiments, the contained liquid could be for example a soap, a sanitizer, a cleanser, a disinfectant or some other foamable liquid. In the exemplary refill unit 30, the liquid reservoir 14 is formed by a rigid housing member. In other embodiments, the liquid reservoir 14 may be formed by a collapsible container such as a flexible bag-like container, or have any other suitable configuration for containing the foamable liquid without leaking. The container 12 may advantageously be refillable, replaceable, or both refillable and replaceable. In other embodiments the container 12 may be neither refillable nor replaceable.

In the event the liquid stored in the reservoir 14 of the installed disposable refill unit 30 runs out, or the installed refill unit 30 otherwise has a failure, the installed refill unit 30 may be removed from the foam dispenser system 50. The empty or failed refill unit 30 may then be replaced with a new refill unit 30 including a liquid-filled reservoir 14.

The housing 52 of the dispenser system 50 further contains one or more actuating members to activate the foam pump 300, such as a manual lever 54. As will be appreciated by one of ordinary skill in the art, there are many different kinds of pump actuators which may be employed in the foam dispenser system. The pump actuator of the foam dispenser system may be any type of actuator, such as, for example, a manual lever, a manual pull bar, a manual push bar, a manual rotatable crank, an electrically activated actuator or other means for actuating the foam pump 300 within the foam dispenser system. Electronic pump actuators may additionally include a motion detector to provide for a hands-free dispenser system with touchless operation. Various intermediate linkages connect an external actuator member to the foam pump 300 within the system housing. Thus, in the embodiment of FIGS. 9 and 10, the actuating member 54 is a U-shaped manual lever. The lever 54 has two legs 56, only one of which is shown in the Figures, which extend into the housing 52. Each leg 56 has a slot 58 formed therein, and is mounted within the housing 52 at a pivot joint 60. The slots 58 respectively receive bosses 62 formed on opposite sides of the foam pump 300 within the dispenser system housing 52.

The exemplary foam pump 300 is a “pull-activated” pump. That is, the pump 300 is actuated by pulling a lower pump body 302 downwardly with respect to an upper pump body 304. The external actuator may be operated in any manner, so long as the intermediate linkages transform that motion to a downward pulling force on the lower pump body 302. Thus, the foam pump 300 is moved from its rest position in FIG. 9 to its activated position in FIG. 10 by a user pulling down on the actuating member 54. The member 54 therefore pivots downwardly around the axis defined by the pivot joints 60. That causes the bosses 62 to move downwardly within the slots 58, thereby translating the downward pivoting movement into a downward vertical movement of the lower pump body 302.

Now referring additionally to FIG. 11, the container 12 is connected to the upper pump body 304 of the foam pump 300. The container 12 has a threaded neck portion 16 which is received within a mating threaded receiving portion 306 of the upper pump body 304. For example, a “quarter turn” rotation may complete the connection between the container 12 and the upper pump body 304. An o-ring or other sealing member 307 may be included to help provide a liquid-tight sealed connection between the two parts of the unit 30.

The foam pump 300 includes several components, including the lower pump body 302, the upper pump body 304, a bottom plate 314, a shuttle valve 318, an external bellows 376 and an internal bellows 378. When the upper pump body 304 is connected to the neck 16 of the container 12, a valve stem portion 310 of the lower pump body 302 extends up into the neck 16 of the container 12. More specifically, the valve stem portion 310 extends up through the sealing member 307 into the neck 16. The neck portion 16, in turn, is held within the upper pump body 304 of the foam pump 300. In one embodiment, the upper pump body 304 may be disposed within the neck 16 of the container 12 with external threads to secure the pump 300 to internal threads in the neck 16.

The lower pump body 302 moves up and down longitudinally within the container 12 and the upper pump body 304. The shuttle valve 318 also moves up and down around the valve stem portion 310 of the lower pump body 302, between a top lip portion 380 and a bottom lip portion 382. These combined movements of the lower pump body 302 and the shuttle valve 318 operate to move liquid through the foam pump 300, as described further below.

FIGS. 9 and 11 illustrate the foam pump 300 in a priming or a primed state, that is, in a rest state before actuation. In that state, the lower pump body 302 is in its upper-most position, and the shuttle valve 318 is in its lower-most position adjacent the bottom lip portion 382. A liquid inlet gate valve 320 is disposed between the liquid reservoir 14 and a liquid charge chamber 322. The liquid charge chamber 322 is defined by the valve stem portion 310, an interior wall 335 of the neck 16, and a sealing member 307. The liquid inlet gate valve 320 is comprised of one or more inlet openings 324 in the valve stem portion 310, and the movable shuttle valve 318. The liquid inlet gate valve 320 opens and closes as the valve stem portion 310 and the shuttle valve 318 move up and down. In the priming or primed state of FIGS. 9 and 11, the valve 320 is in an open position. In that open position, the shuttle valve 318 is in its downward position, exposing the inlet openings 324 to the liquid in the reservoir 14. That exposure permits liquid to be fed under the force of gravity, or by a vacuum created by expansion of liquid charge chamber 322, down from the liquid container 12, through the inlet openings 324 and into the liquid charge chamber 322.

The sealing member 307 at the bottom of the liquid charge chamber 322 prevents liquid from escaping the chamber 322 past the seal 307. The sealing member 307 has an inner wiper seal 332 which rests against the movable valve stem portion 310. As the valve stem portion 310 moves up and down within the sealing member 307, the inner wiper seal 332 slides up and down the exterior surface of the valve stem portion 310 in a liquid-tight manner. In that way, liquid stored in the liquid charge chamber 322 is prevented from escaping downwardly past the seal 307. In addition, a spring-loaded outlet ball valve 336 is closed in the priming or primed state of the pump 300. Thus, when the valve stem portion 310 and the shuttle valve 318 are in their respective positions as shown in FIG. 11, the pump 300 primes itself as liquid begins to enter the liquid charge chamber 322, and becomes fully primed when the chamber 322 is full of liquid.

An air pump 384 disposed underneath the liquid charge chamber 322 is also primed, as shown in FIGS. 9 and 11. The air pump 384 comprises an air chamber 386 defined by the lower pump body 302 at the top, the external bellows portion 376, the bottom plate 314, and the internal bellows portion 378. A one-way air inlet valve 303 disposed in the bottom plate 314 permits the air chamber 386 to be recharged with a new supply of air after the pump 300 is actuated, as described further below. Sanitary sealing through the tortuous path 390 isolates the air pump 384 from the other portions of the foam pump 300 that contact liquid, so that the air pump 384 mechanism does not contact liquid during operation of the foam pump 300.

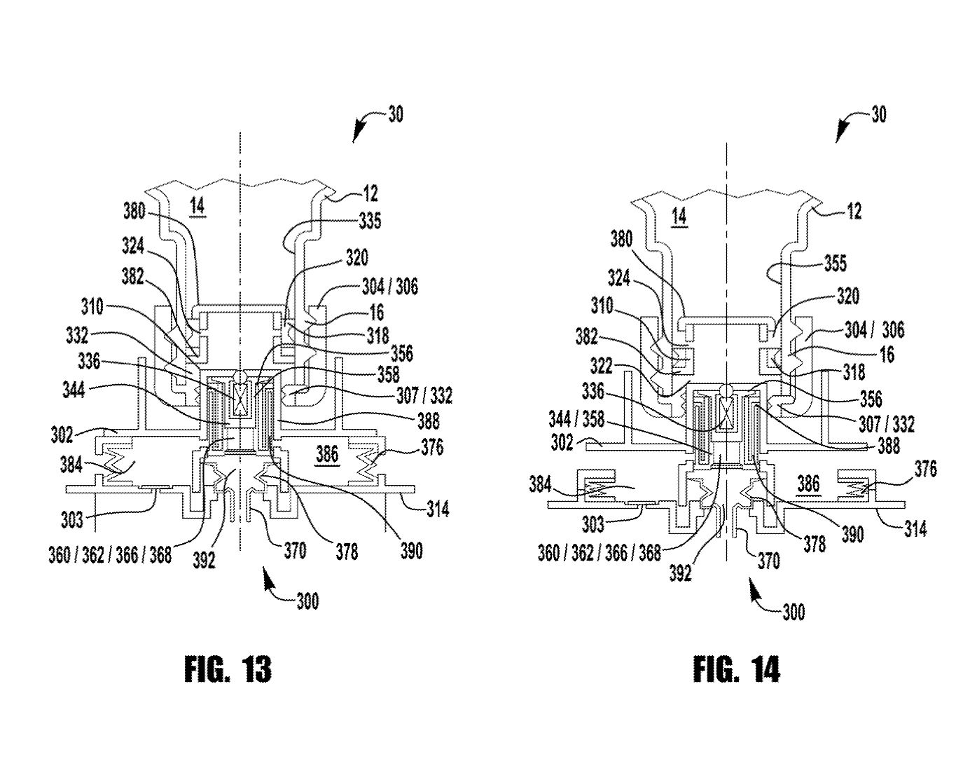

The foam pump 300 is actuated by the actuator in the foam dispensing system, such as the manual lever 54 in dispensing system 50 described above, exerting a downward pulling force on the lower pump body 302. Initially, the frictional force between the shuttle valve 318 and the interior wall 335 of the container 12 prevents the shuttle valve 318 from moving downwardly with the lower pump body 302. In this way, the valve stem portion 310 moves to the intermediate pumping state of FIG. 13. In that state, the top lip portion 380 of the valve stem portion 310 has moved downwardly far enough to contact the shuttle valve 318. At that point, the liquid inlet gate valve 320 is closed because the shuttle valve 318 is covering the inlet openings 324, preventing liquid from being fed down from the liquid container 12 into the liquid charge chamber 322.

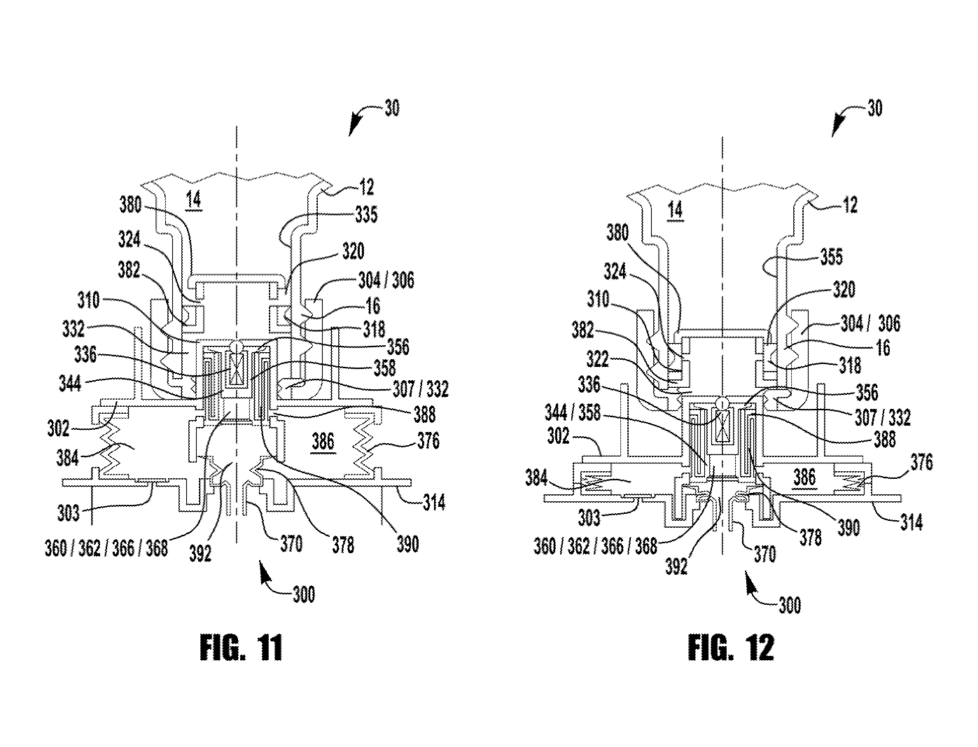

The actuator continues to exert a downward pulling force on the lower body portion 302 of the foam pump 300. The interference between the top lip portion 380 of the valve stem portion 310 and the shuttle valve 318 overcomes the frictional force between the shuttle valve 318 and the interior wall 335 of the container 12. In this way, the lower body portion 302 and the shuttle valve 318 move downwardly together to reach the lower-most final pumping state of FIGS. 10 and 12. As they do so, the volume of the liquid charge chamber 322 decreases, creating a positive pressure on the liquid stored in the chamber 322. The liquid in the chamber 322 is prevented from exiting the top of the chamber 322 via the closed inlet gate valve 320, and from the bottom of the chamber 322 by the sealing member 307. Thus, the only exit path available to the liquid is the spring-loaded outlet ball valve 336.

The closing force exerted by the spring on the ball of the valve 336 is large enough to hold the valve 336 closed when the only opposing opening force is the force of gravity acting on the liquid stored in the liquid charge chamber 322. It is, however, small enough to be overcome and open the valve 336 by the positive pressure arising in the chamber 322 from the decreasing volume of the chamber 322 during a downward stroke of the foam pump 300. As a result, during the downward stroke of the pump 300 moving it from the intermediate state of FIG. 13 to the final pumping state of FIGS. 10 and 12, liquid is forced out of the liquid charge chamber 322 through the liquid outlet gate valve 336. The liquid then travels down through a central liquid delivery conduit 344 within the valve stem portion 310.

The downward movement of the lower pump body 302 during actuation of the pump 300 also operates the air pump 384 underneath the liquid charge chamber 322. As the lower pump body 302 travels downward, the bellows portions 376 and 378 contract, thereby decreasing the volume of the air chamber 386 and creating a positive pressure on the air stored in the chamber 386. The air in the chamber 386 is prevented from exiting the bottom of the chamber 386 via the one-way inlet air valve 303, which permits air to travel only into the chamber 386, not out of the chamber 386. The air in the chamber 386 is thereby forced into one or more air ports 388 in the valve stem portion 310.

The air ports 388 lead to labyrinthine air channels 390 which provide a tortuous path within the valve stem portion 310. The channels 390 lead from the air ports 388 to inner air ports 356 located next to the liquid delivery conduit 344. Liquid flowing down the liquid delivery conduit 344 from the outlet ball valve 336 of the liquid charge chamber 322 mixes with the incoming air from the inner air ports 356 within a mixing chamber 358. The incoming air pressure though the inner air ports 356 helps to prevent liquid and foam in the mixing chamber 358 from entering into the labyrinthine air channels 390. And, to the extent liquid or foam does enter the channels 390, the tortuous path formed by the channels 390 prevents the liquid or foam from reaching the air chamber 386.

In the mixing chamber 358, the foamable liquid moving down the liquid delivery conduit 344 and the pressurized air arriving from the air pump 384 mix together in a swirling motion to form a mixture. Thus, the liquid-air mixture within the mixing chamber 358 is forced by gravity and the incoming air pressure within the liquid delivery conduit 344 into an inlet 360 of a foaming chamber 362.

Within the foaming chamber 362, the liquid-air mixture is enhanced into a rich foam. For example, the foaming chamber 362 may house one or more foaming elements therein. Suitable foaming elements include, for example, one or more screens, meshes, porous membranes or sponges. In addition, one or more of such foaming element(s) may be disposed in a foaming cartridge within the foaming chamber 362. The foam pump 300, for example, has a foaming cartridge 366 with two screen foaming elements 368. As the liquid/air mixture passes through the foaming element(s), the mixture is turned into an enhanced foam. In some embodiments, the mixing and foaming action may both occur in one single chamber, which is then both a mixing chamber and a foaming chamber. The foam is dispensed from the foaming chamber 362 through a foam outlet 370.

In some embodiments, the foam outlet 370 is simply an aperture leading from the foaming chamber 362 directly to the outside atmosphere surrounding the foam dispenser system. In other embodiments, the foam outlet 370 may optionally include tubing or other delivery conduits to carry the foam from the foaming chamber 362 to such an aperture. For example, in the pump 300, such a conduit is formed by the internal bellows portion 378. In additional embodiments, the foam outlet 370 may optionally include one or more one-way check valves (not shown) to prevent back flow of foam from the foam outlet 370 into the foaming chamber 362 or to prevent unwanted liquid or foam discharge while the dispenser is not being used. Suitable one-way check valves may include a flapper valve, a conical valve, a plug valve, an umbrella valve, a duck-bill valve, a ball valve, a slit valve, a mushroom valve, a spring and ball valve, or any other one-way check valve. Similar one-way check valves may optionally be placed in other portions of the liquid delivery path from the liquid reservoir 14 to the mixing chamber 358 and then to the foam outlet 370, as desirable or necessary. They may, for example, be placed in the inner air ports 356 to ensure liquid cannot escape the liquid delivery conduit 344.

In a preferred embodiment, the air to liquid ratio in the mixture formed in the mixing chamber 358 is approximately 10:1, but any ratio may be provided. The air to liquid ratio is determined by the volume and pressure of the air being delivered by the air pump 384, and the amount of liquid entering the mixing chamber 358 from the liquid delivery conduit 344. Once these and other applicable design variables are chosen to provide the desired air to liquid ratio, a consistently accurate dosing is thereafter provided. The volume of liquid may also be varied by adjusting the stroke of the valve stem portion 310.

The lower pump body 302 and the shuttle valve 318 move downward until they stop. FIGS. 10 and 12 illustrate a lower-most position, wherein further downward movement is prevented by interference between the lower pump body 302 and the bottom plate 314. That position represents the maximum pumping stroke of the lower pump body 302, producing the maximum amount of foam. The pumping actuator of the system may, however, stop the downward movement before that maximum displacement is reached, to reduce the amount of foam dispensed as desired by the user.

Regardless of the length of the pumping stroke, when downward movement of the lower pump body 302 and the shuttle valve 318 stops, the foaming and pumping actions also stop. The relative positions of the valve stem portion 310 and the shuttle valve 318 will then be as shown in FIG. 12. In that configuration, the liquid inlet gate valve 320 is closed.

At that time, a restoring force pushes the lower pump body 302 to move upwardly with respect to the upper pump body 304 and the bottom plate 314. The restoring force may be provided, for example, by a resilient nature of the bellows portions 376 and 378. It may also be provided by a compressed coil spring (not shown) disposed in the air chamber 386 and pushing up on the lower pump body 302. In such embodiments, the downward actuating force provided by the pump actuator overcomes the upward bias of the bellows and/or coil spring in order to perform the pumping action illustrated by FIGS. 11, 12 and 13. Then the downward force is removed, permitting the bellows and/or coil spring to push the lower pump portion 302 upwardly. The restoring force may alternatively or additionally be provided by the actuator itself exerting an upward force on the lower pump body 302.

As the lower pump body 302 initially begins its upward travel, the frictional force between the shuttle valve 318 and the interior wall 335 of the container 12 prevents the shuttle valve 318 from moving upwardly within the container 12. In this way, the pump 300 moves to the intermediate pumping state of FIG. 14. In that state, the valve stem portion 310 has moved upwardly far enough that the shuttle valve 318 contacts the bottom lip portion 382. Therefore, at that point, the liquid inlet gate valve 320 is open.

The restoring force continues to exert an upward pushing force on the lower valve body 302. The interference between the bottom lip portion 382 of the valve stem portion 310 and the shuttle valve 318 overcomes the frictional force between the shuttle valve 318 and the interior wall 335 of the container 12. In this way, the valve stem portion 310 and the shuttle valve 318 move upwardly together to reach the upper-most priming or primed state of FIGS. 9 and 11. At that point further upward movement is prevented by interference between the lower body portion 302 and the sealing member 307 or the upper body portion 304.

As the lower body portion 302 and the shuttle valve 318 move upwardly, the volume of the liquid charge chamber 322 increases. Liquid stored in the liquid reservoir 14 is free to move down into the liquid charge chamber 322 through the open liquid inlet gate valve 320. It does so by the force of gravity and by the negative hydraulic pressure generated by the sealed (other than the open valve 320) chamber 322. The outlet ball valve 336 prevents the liquid from exiting the chamber 322 into the mixing chamber 358. Thus, liquid will continue to fill the chamber 322 until it is full, readying the pump 300 for another actuation.

At the same time, both of the bellows portions 376 and 378 are expanding. This has at least two effects. First, the volume of the air chamber 386 in the air pump 384 increases, creating a negative air pressure within the air chamber 386. That negative air pressure opens the one-way air inlet valve 303 to let air into the chamber 386, thus recharging the air pump 384.

Second, the volume of an outlet chamber 392, formed by the internal bellows portion 376 near the foam outlet 370, also increases. That likewise creates a negative air pressure in the outlet chamber 392, which will tend to create a suction force to pull back foam from the foam outlet 270 as the pump 300 expands. The foam outlet 370 may optionally include one or more one-way check valves, as discussed above, in order to aid this process. In this way, the foam pump 300 incorporates an “anti-drip” feature.

During operation of the foam pump 300, the air pump 384 preferably remains dry or free from liquids and foamy mixtures, to prevent bacteria from growing in that area. This is accomplished by the tortuous path of the labyrinthine channels 390. For example, the tortuous path may include changes in angular direction that add up to at least 180 degrees, at least 270 degrees, at least 360 degrees, or more. Optionally, one-way valves as discussed above may be added to the air ports 356 to further ensure that liquid does not contaminate the air pump 384.

The disposable refill unit including the wet portions of the foam pump 300 has many advantages. Among them is the ease by which the unit may be prepared for shipping and delivery to an end user location, without leakage. If the unit 30 is packed with the lower pump body 302 held in the lowermost position of FIGS. 10 and 12, the liquid inlet gate valve 320 will correspondingly be held closed to prevent liquid from escaping the reservoir 14. This can easily be accomplished with appropriate packaging materials.

Indeed, another potential benefit provided by the foam pump 300 is that it may be used to provide a small pump mechanism. This size advantage arises, in part, because many of the foam pump 300 components extend up into the neck 16 of the container 12. And, in some cases the diameter of the foam screens 368 may be no more than about 0.06″ in diameter. Further, in one embodiment, substantially all of the working components of the pump 300 are located within the neck 16 of the container 12. For example, at least fifty percent (50%) of the pump components may fit wholly or partly within the neck portion 16.

At least a portion of the air pump 384 may remain attached to the dispenser 50, such as the bellows 376 and the bottom plate 314. Such portions of the air pump 384 are advantageously reusable, so that they do not need to be disposed of and replaced with the refill unit 30.

FIGS. 15-18 illustrate a fourth exemplary embodiment of a disposable refill unit 40, which may be used for example in the foam dispenser system 50. Referring initially to FIG. 15, the disposable refill unit 40 includes a container 12 connected to a foam pump 400. The disposable refill unit 40 may be placed within the same foam dispenser system 50 which is discussed above in connection with the disposable refill unit 30. The disposable refill unit 40 fits and operates within the dispenser system 50 in the same way as the disposable refill unit 30. Therefore, a detailed discussion of the dispenser system 50 and its interaction with the unit 40 is omitted here, having already been described above. The disposable refill unit 40 may alternatively be used in a counter-mounted system, an un-mounted portable system movable from place to place, or any other kind of foam dispenser system.

The foam pump 400 includes many components which are similar to, or at least perform similar functions as, corresponding components within the foam pump 300. Such components are identified by reference numerals having a different leading digit but the same final two digits. Thus, for example, the foam pump 400 has an air pump 484 which is similar to the air pump 384 of the foam pump 300. The foam pump 400 also has a moveable valve stem portion 410 which performs a similar function to the valve stem portion 310 of the foam pump 300, but in some respects the two valve stem portions 310, 410 are structurally different.

The container 12 forms a liquid reservoir 14. The liquid reservoir 14 contains a supply of a foamable liquid within the disposable refill unit 40 and the dispensing system housing which holds the unit 40. In various embodiments, the contained liquid could be for example a soap, a sanitizer, a cleanser, a disinfectant or some other foamable liquid. In the exemplary disposable refill unit 40, the liquid reservoir 14 is formed by a rigid housing member. In other embodiments, the liquid reservoir 14 may be formed by a collapsible container such as a flexible bag-like container, or have any other suitable configuration for containing the foamable liquid without leaking. The container 12 may advantageously be refillable, replaceable, or both refillable and replaceable. In other embodiments the container 12 may be neither refillable nor replaceable.

In the event the liquid stored in the reservoir 14 of the installed disposable refill unit 40 runs out, or the installed refill unit 40 otherwise has a failure, the installed refill unit 40 may be removed from the foam dispenser system. The empty or failed refill unit 40 may then be replaced with a new refill unit 40 including a liquid-filled reservoir 14.

The foam pump 400 includes several components, including a lower pump body 402, an upper pump body 404, a bottom plate 414, a shuttle valve 418, an external bellows 476 and an internal bellows 478. When the upper pump body 404 is connected to the container 12, a valve stem portion 410 of the lower pump body 402 extends up into the neck 16 of the container 12. More specifically, the valve stem portion 410 extends up through a sealing member 407 into the neck 16 of the container 12. The neck portion 16, in turn, is held within the upper pump body 404 of the foam pump 400. In one embodiment, the upper pump body 404 may be disposed within the neck 16 of the container 12 with external threads to secure the pump 100 to internal threads in the neck 16.

In the particular foam pump 400 embodiment illustrated in the Figures, the valve stem portion 410 is composed of three separate parts 410A, 410B and 410C which snap or otherwise connect together to form the valve stem portion 410. The valve stem portion 410 in turn is connected to a plate 402B to form the lower pump body 402. This design aids the assembly process for making the pump 400. In use, the four parts 410A, 410B, 410C and 402B function as one integral lower pump body 402. In other embodiments, the lower pump body 402 may be composed of one integral piece, or other numbers of connected parts.

A gasket or seal 499 forms a seal between valve stem 410 and lower pump body 402. In one embodiment, seal 499 contains a surface having an adhesive covered by a peel away film (not shown). Prior to installing the refill unit 40, which has a seal 499 attached to valve stem 410, the peel away film is removed. Thus, when the refill unit 40 is placed in the foam dispenser 50, seal 499 adhesively bonds with lower pump body 402. The adhesive bond has enough strength to temporarily bond lower valve body 402 to valve stem 410 during operation of the foam dispenser 50, but is weak enough so that the bond is easily broken when the refill unit 40 is being replaced.

The lower pump body 402 moves up and down longitudinally within the container 12 and the upper pump body 404. The shuttle valve 418 also moves up and down around the valve stem portion 410 of the lower pump body 402, between a top lip portion 480 and a bottom lip portion 482. These combined movements of the lower pump body 402 and the shuttle valve 418 operate to move liquid through the foam pump 400, as described further below.

FIG. 15 illustrates the foam pump 400 in a priming or a primed state, that is, in a rest state before actuation. In that state, the lower pump body 402 is in its upper-most position, and the shuttle valve 418 is in its lower-most position adjacent the bottom lip portion 482. A liquid inlet gate valve 420 is disposed between the liquid reservoir 14 and a liquid charge chamber 422. Apertures 493 provided in the valve stem part 410A permit fluid communication such that the liquid charge chamber 422 includes an interior cavity of the part 410A as well as an annular space between the valve stem part 410C and the interior wall 435 of the container 12 above the sealing member 407. The liquid inlet gate valve 420 is comprised of one or more inlet openings 424 in the valve stem portion 410, and the movable shuttle valve 418. The liquid inlet gate valve 420 opens and closes as the valve stem portion 410 and the shuttle valve 418 move up and down. In the priming or primed state of FIG. 15, the valve 420 is in an open position. In that open position, the shuttle valve 418 is in its downward position, exposing the inlet openings 424 to the liquid in the reservoir 14. That exposure permits liquid to be fed under the force of gravity down from the liquid container 12, through the inlet openings 424 and into the liquid charge chamber 422.

The sealing member 407 at the bottom of the liquid charge chamber 422 prevents liquid from escaping the chamber 422 past the seal 407. The sealing member 407 has an inner wiper seal 432 which rests against the movable valve stem portion 410. As the valve stem portion 410 moves up and down within the sealing member 407, the inner wiper seal 432 slides up and down the exterior surface of the valve stem portion 410 in a liquid-tight manner. In that way, liquid stored in the liquid charge chamber 422 is prevented from escaping downwardly past the seal 407. In addition, a liquid outlet gate valve 436 is closed in the priming or primed state of the pump 400. Thus, when the valve stem portion 410 and the shuttle valve 418 are in their respective positions as shown in FIG. 15, the pump 400 primes itself as liquid begins to enter the liquid charge chamber 422, and becomes fully primed when the chamber 422 is full of liquid.

An air pump 484 disposed underneath the liquid charge chamber 422 is also primed, as shown in FIG. 15. The air pump 484 comprises an air chamber 486 defined by the lower pump body plate 402B at the top, the external bellows portion 476, the bottom plate 414, and the internal bellows portion 478. A one-way air inlet valve 403 disposed in the bottom plate 414 permits the air chamber 486 to be recharged with a new supply of air after the pump 400 is actuated, as described further below. Sanitary sealing 498 isolates the air pump 484 from the other portions of the foam pump 400 that contact liquid, so that the air pump 484 mechanism does not contact liquid during operation of the foam pump 400.

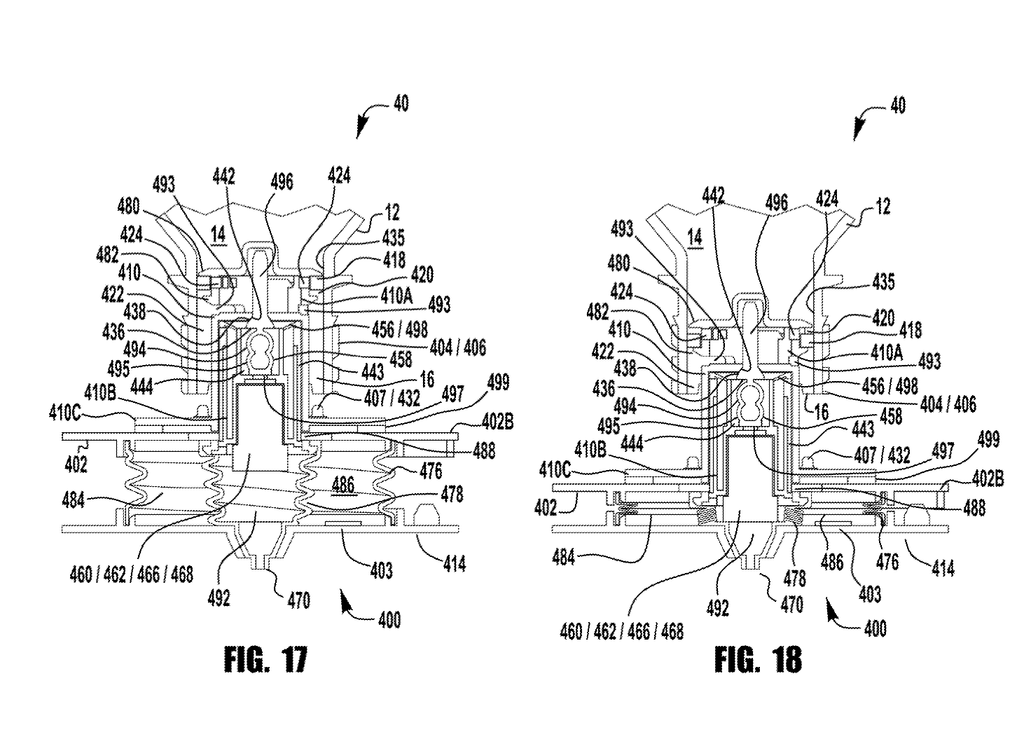

The foam pump 400 is actuated by the actuator in the foam dispensing system exerting a downward pulling force on the lower pump body 402. Initially, the frictional force between the shuttle valve 418 and the interior wall 435 of the container 12 prevents the shuttle valve 418 from moving downwardly with the lower pump body 402. In this way, the valve stem portion 410 moves to the intermediate pumping state of FIG. 17. In that state, the top lip portion 480 of the valve stem portion 410 has moved downwardly far enough to contact the shuttle valve 418. At that point, the liquid inlet gate valve 420 is closed because the shuttle valve 418 is covering the inlet openings 424, preventing liquid from being fed under the force of gravity down from the liquid container 12 into the liquid charge chamber 422.

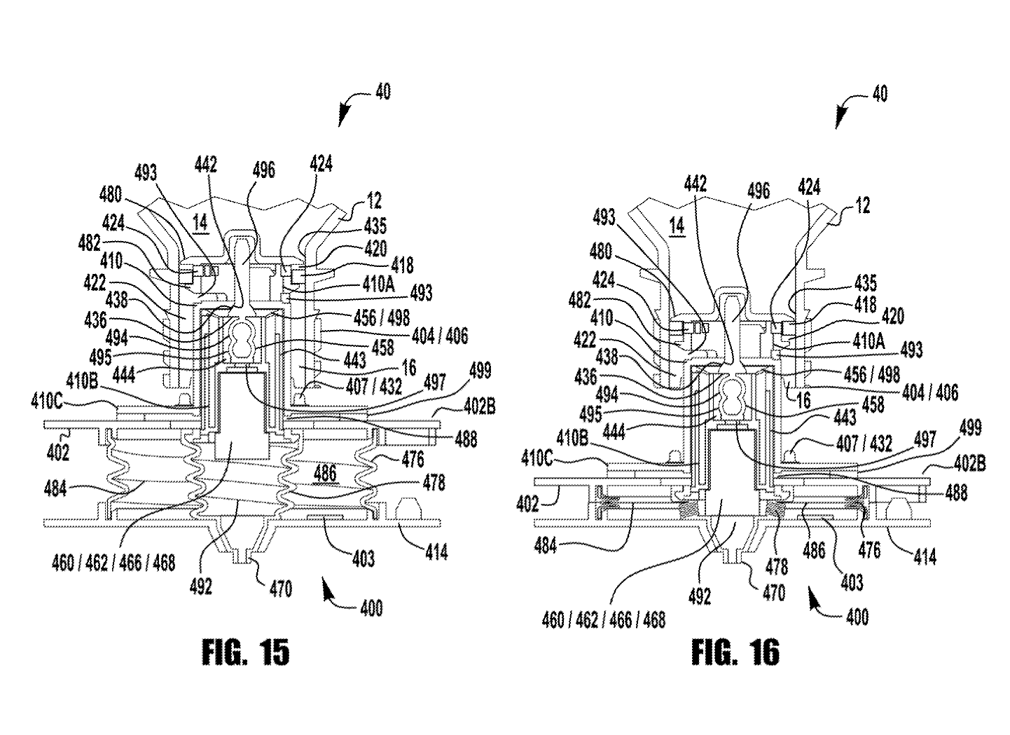

The actuator continues to exert a downward pulling force on the lower body portion 402 of the foam pump 400. The interference between the top lip portion 480 of the valve stem portion 410 and the shuttle valve 418 overcomes the frictional force between the shuttle valve 418 and the interior wall 435 of the container 12. In this way, the lower body portion 402 and the shuttle valve 418 move downwardly together to reach the lower-most final pumping state of FIG. 16. As they do so, the volume of the liquid charge chamber 422 decreases, creating a positive pressure on the liquid stored in the chamber 422. The liquid in the chamber 422 is prevented from exiting the top of the chamber 422 by the closed inlet gate valve 420, and from the bottom of the chamber 422 by the sealing member 407. Thus, the only exit path available to the liquid is the liquid outlet gate valve 436.

The liquid outlet gate valve 436 is disposed between the liquid charge chamber 422 and a mixing chamber 458 within the valve stem portion 410. The valve 436 has a valve member 494 which includes an elastomeric spring portion 495 integrally connected to an upwardly extending valve portion 496. The liquid outlet gate valve 436 is comprised of a first valve surface 438 formed on the valve portion 496 and a second valve surface 442 formed on the valve stem part 410C. The liquid outlet gate valve 436 opens and closes as the valve portion 496 moves up and down. In the priming or primed state of FIG. 15, the valve 436 is in a closed position. In that closed position, the first valve surface 438 is pressed into contact with the second valve surface 442 by the compressed elastomeric spring portion 495, which rests on the floor 497 of the mixing chamber 458. That contact prevents liquid from passing out of the liquid charge chamber 422 through the liquid outlet gate valve 436. Other types of one-way valves, such as those described throughout the specification may be used a liquid outlet gate valve.

The closing force exerted by the elastomeric spring portion 495 is large enough to hold the valve 436 closed when the only opposing opening force is the force of gravity acting on the liquid stored in the liquid charge chamber 422. It is, however, small enough to be overcome and open the valve 436 by the positive pressure arising in the chamber 422 from the decreasing volume of the chamber 422 during a downward stroke of the foam pump 400. As a result, during the downward stroke of the pump 400 moving it from the intermediate state of FIG. 17 to the final pumping state of FIG. 16, the first valve surface 438 is separated from the second valve surface 442. Liquid is thereby forced out of the liquid charge chamber 422 through the opened liquid outlet gate valve 436. The liquid then travels down through a central liquid delivery conduit 444 within the valve stem portion 410 which includes the mixing chamber 458.

The downward movement of the lower pump body 402 during actuation of the pump 400 also operates the air pump 484 underneath the liquid charge chamber 422. As the lower pump body 402 travels downward, the bellows portions 476 and 478 contract, thereby decreasing the volume of the air chamber 486 and creating a positive pressure on the air stored in the chamber 486. The air in the chamber 486 is prevented from exiting the bottom of the chamber 486 via the one-way inlet air valve 403, which permits air to travel only into the chamber 486, not out of the chamber 486. The air in the chamber 486 is thereby forced into one or more air ports 488 in the lower pump body 402.

The air ports 488 lead to vertical air channels 443 within the valve stem portion 410. The vertical air channels 443 lead from the air ports 488 to inner air ports 456 located next to the liquid delivery conduit 444. A wiper seal 498 is located next to the inner air ports 456. The pressure of the air arriving from the chamber 486 opens the wiper seal 498 so that the air passes through the ports 456 and into the mixing chamber 458. Liquid flowing down the liquid delivery conduit 444 from the liquid outlet gate valve 436 mixes with the incoming air from the inner air ports 456 within the mixing chamber 458. The incoming air pressure though the inner air ports 456 helps to prevent liquid and foam in the mixing chamber 458 from entering into the vertical air channels 443. Wiper seal 498 closes when the air pressure is removed.

In the mixing chamber 458, the foamable liquid moving down the liquid delivery conduit 444 and the pressurized air arriving from the air pump 484 mix together in a swirling motion to form a mixture. Thus, the liquid-air mixture within the mixing chamber 458 is forced by gravity and the incoming air pressure within the liquid delivery conduit 444 into an inlet 460 of a foaming chamber 462. In the pump 400, the inlet 460 is formed by one or more apertures (not shown) in the floor 497 of the mixing chamber 458.

Within the foaming chamber 462, the liquid-air mixture is enhanced into a rich foam. For example, the foaming chamber 462 may house one or more foaming elements therein. Suitable foaming elements include, for example, one or more screens, meshes, porous membranes or sponges. In addition, one or more of such foaming element(s) may be disposed in a foaming cartridge within the foaming chamber 462. The foam pump 400, for example, has a foaming cartridge 466 with two screen foaming elements 468. As the liquid/air mixture passes through the foaming element(s), the mixture is turned into an enhanced foam. In some embodiments, the mixing and foaming action may both occur in one single chamber, which is then both a mixing chamber and a foaming chamber. The foam is dispensed from the foaming chamber 462 through a foam outlet 470.

In some embodiments, the foam outlet 470 is simply an aperture leading from the foaming chamber 462 directly to the outside atmosphere surrounding the foam dispenser system. In other embodiments, the foam outlet 470 may optionally include tubing or other delivery conduits to carry the foam from the foaming chamber 462 to such an aperture. For example, in the pump 400, such a conduit is formed by the internal bellows portion 478. In additional embodiments, the foam outlet 470 may optionally include one or more one-way check valves (not shown) to prevent back flow of foam from the foam outlet 470 into the foaming chamber 462 or to prevent unwanted liquid or foam discharge while the dispenser is not being used. Suitable one-way check valves may include a flapper valve, a conical valve, a plug valve, an umbrella valve, a duck-bill valve, a ball valve, a slit valve, a mushroom valve, a spring and ball valve, or any other one-way check valve. Similar one-way check valves may optionally be placed in other portions of the liquid delivery path from the liquid reservoir 14 to the mixing chamber 458 and then to the foam outlet 470, as desirable or necessary. For example, the wiper seal valve 498 placed next to the inner air ports 456 ensures liquid cannot escape the liquid delivery conduit 444 and into the vertical air channels 443.

In a preferred embodiment, the air to liquid ratio in the mixture formed in the mixing chamber 458 is approximately 10:1, but any ratio may be provided. The air to liquid ratio is determined by the volume and pressure of the air being delivered by the air pump 484, and the amount of liquid entering the mixing chamber 458. Once these and other applicable design variables are chosen to provide the desired air to liquid ratio, a consistently accurate dosing is thereafter provided. The volume of liquid may be varied by adjusting the stroke of the valve stem portion 410.

The lower pump body 402 and the shuttle valve 418 move downward until they stop. FIG. 16 illustrates a lower-most position, wherein further downward movement is prevented by interference between the lower pump body plate 402B and the bottom plate 414. That position represents the maximum pumping stroke of the lower pump body 402, producing the maximum amount of foam. The pumping actuator of the system may, however, stop the downward movement before that maximum displacement is reached, to reduce the amount of foam dispensed as desired by the user.

Regardless of the length of the pumping stroke, when downward movement of the lower pump body 402 and the shuttle valve 418 stops, the foaming and pumping actions also stop. The relative positions of the valve stem portion 410 and the shuttle valve 418 will then be as shown in FIG. 16. In that configuration, the liquid inlet gate valve 420 is closed.

At that time, a restoring force pushes the lower pump body 402 to move upwardly with respect to the upper pump body 404 and the bottom plate 414. The restoring force may be provided, for example, by a resilient nature of the bellows portions 476 and 478. It may also be provided by a compressed coil spring (not shown) disposed in the air chamber 486 and pushing up on the lower pump body plate 402B. In such embodiments, the downward actuating force provided by the pump actuator overcomes the upward bias of the bellows and/or coil spring in order to perform the pumping action illustrated by FIGS. 15, 16 and 17. Then the downward force is removed, permitting the bellows and/or coil spring to push the lower pump portion 402 upwardly. The restoring force may alternatively or additionally be provided by the actuator itself exerting an upward force on the lower pump body 402.

As the lower pump body 402 initially begins its upward travel, the frictional force between the shuttle valve 418 and the interior wall 435 of the container 12 prevents the shuttle valve 418 from moving upwardly within the container 12. In this way, the pump 400 moves to the intermediate pumping state of FIG. 18. In that state, the valve stem portion 410 has moved upwardly far enough that the shuttle valve 418 contacts the bottom lip portion 482. Therefore, at that point, the liquid inlet gate valve 420 is open.

The restoring force continues to exert an upward pushing force on the lower valve body 402. The interference between the bottom lip portion 482 of the valve stem portion 410 and the shuttle valve 418 overcomes the frictional force between the shuttle valve 418 and the interior wall 435 of the container 12. In this way, the valve stem portion 410 and the shuttle valve 418 move upwardly together to reach the upper-most priming or primed state of FIG. 15. At that point further upward movement is prevented by interference between the lower body portion plate 402B and the sealing member 407 or the upper body portion 404.

As the lower body portion 402 and the shuttle valve 418 move upwardly, the volume of the liquid charge chamber 422 increases. Liquid stored in the liquid reservoir 14 is free to move down into the liquid charge chamber 422 through the open liquid inlet gate valve 420. It does so by the force of gravity and by the negative hydraulic pressure generated by the sealed (other than the open valve 420) chamber 422. The closed liquid outlet gate valve 436 prevents the liquid from exiting the chamber 422 into the mixing chamber 458. Thus, liquid will continue to fill the chamber 422 until it is full, readying the pump 400 for another actuation.

At the same time, both of the bellows portions 476 and 478 are expanding. This has at least two effects. First, the volume of the air chamber 486 in the air pump 484 increases, creating a negative air pressure within the air chamber 486. That negative air pressure opens the one-way air inlet valve 403 to let air into the chamber 486, thus recharging the air pump 484.

Second, the volume of an outlet air chamber 492, formed by the internal bellows portion 476 near the foam outlet 470, also increases. That likewise creates a negative air pressure in the outlet air chamber 492, which will tend to create a suction force to pull back foam from the foam outlet 270 as the pump 400 expands. The foam outlet 470 may optionally include one or more one-way check valves, as discussed above, in order to aid this process. In this way, the foam pump 400 incorporates an “anti-drip” feature.

During operation of the foam pump 400, the air pump 484 preferably remains dry or free from liquids and foamy mixtures, to prevent bacteria from growing in that area. This is accomplished by the wiper seal 498.

The disposable refill unit 40 including the wet portions of the foam pump 400 has many advantages. Among them is the ease by which the unit may be prepared for shipping and delivery to an end user location, without leakage. If the unit 40 is packed with the lower pump body 402 held in the lowermost position of FIG. 16, the liquid inlet gate valve 420 will correspondingly be held closed to prevent liquid from escaping the reservoir 14. This can easily be accomplished with appropriate packaging materials.

Indeed, another potential benefit provided by the foam pump 400 is that it may be used to provide a small pump mechanism. This size advantage arises, in part, because many of the foam pump 400 components extend up into the neck 16 of the container 12. And, in some cases the diameter of the foam screens 468 may be no more than about 0.06″ in diameter. Further, in one embodiment, substantially all of the working components of the pump 400 are located within the neck 16 of the container 12. For example, at least fifty percent (50%) of the pump components may fit wholly or partly within the neck portion 16.

At least a portion of the air pump 484 may remain attached to the dispenser 50, when the refill unit 40 is removed from the dispenser 50. These portions may include lower pump body 402, bellows portion 476 and lower plate 414. Such portions of the air pump 484 are advantageously reusable because they do not come in contact with liquid during operation of the pump. Thus, they do not need to be disposed of and replaced with the refill unit 40. The refill unit 40 including valve same 410 and bellows portion 478 are readily removable upward from lower pump body, bellows 476 and bottom plate 470, which are secured to the foam dispenser 50.

The above-described removable and replaceable refill units 10, 20, 30 and 40 for a foam dispenser system may be manufactured and assembled in any convenient manner. Such methods including providing the various parts for building the foam pump 100, 200, 300 or 400, and then assembling the parts into a completed pump. Then a liquid container is filled with a supply of foamable liquid, and connected to the completed pump in order to form a refill unit. No particular order is required to perform these processes, and various combinations or groupings of different steps may be used in accordance with the present invention.

While the present invention has been illustrated by the description of embodiments thereof and while the embodiments have been described in considerable detail, it is not the intention of the applicants to restrict or in any way limit the scope of the appended claims to such detail. Additional advantages and modifications will readily appear to those skilled in the art. Moreover, elements described with one embodiment may be readily adapted for use with other embodiments. Therefore, the invention, in its broader aspects, is not limited to the specific details, the representative apparatus and illustrative examples shown and described. Accordingly, departures may be made from such details without departing from the spirit or scope of the applicants' general inventive concept.

We claim:

1. A foam pump comprising:
a housing;
a valve stem located at least partially within the housing, wherein the valve stem moves in opposite first and second directions along a longitudinal axis, and the valve stem has an inlet liquid pathway configured to convey liquid to a liquid charge chamber, and an outlet liquid pathway configured to convey liquid from the liquid charge chamber to a mixing chamber for mixing liquid and air together;
a valve body movable between a first position and a second position with respect to the valve stem, wherein the valve body opens the inlet liquid pathway in the first position, and opens the outlet liquid pathway in the second position;
wherein movement of the valve stem in the first direction moves the valve body to the first position, and movement of the valve stem in the second direction moves the valve body to the second position.

2. The pump of claim 1 wherein the valve body closes the outlet liquid pathway in the first position, and closes the inlet liquid pathway in the second position.

3. The pump of claim 2 wherein the longitudinal axis is a vertical axis aligned with a force of gravity acting on the liquid, such that the first direction is an upward direction with respect to gravity and the second direction is a downward direction with respect to gravity.

4. The pump of claim 2 wherein the valve body comprises a shuttle disk having an aperture which receives the valve stem so that the shuttle disk may slide along the longitudinal axis with respect to the valve stem, between the first position and the second position.

5. The pump of claim 4, wherein the valve stem further comprises a bottom lip portion that contacts the shuttle disk in the first position and a top lip portion that contacts the shuttle disk in the second position.

6. The pump of claim 2 wherein the valve body comprises a flexible disk having an aperture which receives the valve stem so that the flexible disk is held in place along the longitudinal axis with respect to the valve stem, and the valve stem comprises a bottom valve surface portion that contacts the flexible disk in the first position but not in the second position, and a top guide disk portion that contacts the flexible disk in the second position.

7. The pump of claim 1 wherein the housing further comprises an air inlet opening and an air pathway, wherein the air inlet opening is connectable to an air pump located outside of the housing, and the air pathway leads from the air inlet opening to the mixing chamber.

8. The pump of claim 7 further comprising a sanitary seal located in the air pathway to prevent liquid from contaminating the air pump.

9. The pump of claim 1 furthering comprising an air gasket disposed at least partly within the housing, wherein the air gasket forms at least a portion of a floor of the liquid charge chamber, and the air gasket comprises an inner wiper seal which surrounds the movable valve stem to provide a liquid-tight seal which inhibits liquid from traveling between the inner wiper seal and the valve stem.

10. The pump of claim 9 wherein the housing further comprises an air inlet opening and an air pathway, wherein the air inlet opening is connectable to an air pump located outside of the housing, and the air pathway leads from the air inlet opening to the mixing chamber.

11. The pump of claim 10 wherein the mixing chamber is disposed within the valve stem, and the air pathway additionally comprises an air inlet opening located in a wall of the valve stem.

12. The pump of claim 10 wherein the air pathway is disposed in part underneath the floor of the liquid charge chamber such that when the air pump supplies pressurized air to the liquid foam pump the pressurized air moves past the inner wiper seal of the air gasket and into the liquid charge chamber.

13. The pump of claim 1 further comprising a drip catch located at least partially within the valve stem.

14. The pump of claim 1 further comprising a foaming cartridge located at least partially within the valve stem.

15. The pump of claim 14 wherein the foam cartridge comprises a plurality of screens, wherein each one of the plurality of screens has a diameter of less than about 0.06 inches.

16. A disposable refill unit for a foam dispenser system comprising the liquid foam pump of claim 1 in combination with a container, wherein the housing of the liquid foam pump comprises a receiving portion which is connectable to a neck portion of the container to form the disposable refill unit.

17. The disposable refill unit of claim 16 wherein at least 50% of the liquid pump components fit within the neck of the container.

18. A foam pump comprising:
a liquid charge chamber with a liquid inlet and a first valve through which liquid may enter the liquid charge chamber, and a liquid outlet and a second valve through which liquid may pass from the liquid charge chamber;
a mixing chamber with a liquid inlet to receive liquid from the liquid outlet of the liquid charge chamber, and an air inlet to receive pressurized air from a pressurized air source, such that the liquid and the pressurized air are mixed within the mixing chamber to form a foamable mixture;
a foam enhancing media which receives the foamable mixture, wherein a foaminess of the foamable mixture is enhanced as it passes through the foam enhancing media;
an outlet nozzle for dispensing the enhanced foamable mixture; and
a suck-back mechanism to prevent foam that is not dispensed during a pumping action from dripping out of the outlet nozzle after the pumping action is completed;
wherein when the refill unit is installed in a dispenser, a portion of the suck-back mechanism forms a portion of an air pump that is disposed within the foamable liquid dispenser; and
wherein the refill unit is disposable without disposing of the entire air pump.

19. The pump of claim 18 wherein the suck-back mechanism includes a tortuous path wherein the tortuous path comprises a total of more than a 180 degree change in direction along the tortuous path and wherein the portion of the tortuous path located near the air compressor is configured to remain substantially free of liquid during operation.

20. The pump of claim 18 wherein the suck-back mechanism comprises a bellows wherein a first side of the bellows forms a portion of a foam outlet passage and a second side of the bellows forms a wall of an air pump.

21. A disposable refill unit for a foam dispenser system comprising the foam pump of claim 18 in combination with a container, wherein a housing of the liquid foam pump comprises a receiving portion which is connectable to a neck portion of the container to form the disposable refill unit.

22. A refill unit for a foam dispenser comprising:
a container for a foamable liquid;
a pump;
the pump having
a liquid charge chamber with a liquid inlet and a first valve through which liquid may enter the liquid charge chamber, and a liquid outlet and a second valve through which liquid may pass from the liquid charge chamber;
a mixing chamber having a liquid inlet to receive liquid from the liquid outlet of the liquid charge chamber, and an air inlet to receive pressurized air from a pressurized air source, such that the liquid and the pressurized air are mixed within the mixing chamber to form a foamable mixture;
a foam enhancing media which receives the foamable mixture, wherein a foaminess of the foamable mixture is enhanced as it passes through the foam enhancing media;
an outlet nozzle for dispensing the enhanced foamable mixture; and
a suck-back mechanism to prevent foam that is not dispensed during a pumping action from dripping out of the outlet nozzle after the pumping action is completed, wherein the suck-back mechanism is a bellows and a first portion of the bellows forms an outlet passageway for the foam to pass through and a second portion of the bellows forms a portion of an air compressor when the refill unit is secured to the foamable liquid mechanism;
wherein the pressurized air source is disposed within the foamable liquid dispenser and comprises a pressurized air outlet, and the refill unit is configured to be releasably secured to the foamable liquid dispenser such that the pressurized air outlet of the dispenser communicates with the air inlet of the mixing chamber when the refill unit is secured to the foam dispenser; and
wherein the refill unit is disposable without disposing of the pressurized air source.

23. The pump of claim 22 wherein the suck-back mechanism further comprises a tortuous path between the foam dispenser and the air compressor and wherein the tortuous path comprises changes in angular directions that add up to at least 180 degrees and wherein a portion of the tortuous path near the air compressor is configured to remain substantially free of liquid during operation.

24. The pump of claim 23 wherein the tortuous path comprises changes in angular directions that add up to at least 270 degrees.

25. The pump of claim 22 further comprising an air inlet valve located within the liquid pump that permits air to enter into the liquid pump and prevents air from exiting out of the liquid pump.
